(19) United States
(12) Patent Application Publication
(10) Pub. No.: US 2017/0131884 A1
(43) Pub. Date: May 11, 2017

(54) MOBILE DEVICE MESSAGING APPLICATION

(71) Applicant: LG Electronics Inc., Seoul (KR)

(72) Inventors: Yongwook JEON, Seoul (KR); Eugene MYUNG, Seoul (KR); Sooyon CHUNG, Seoul (KR); Nayeoung KIM, Seoul (KR); Yoonchan WON, Seoul (KR); Juhyun LEE, Seoul (KR)

(21) Appl. No.: 15/091,787

(22) Filed: Apr. 6, 2016

(30) Foreign Application Priority Data
Nov. 6, 2015 (KR) 10-2015-0155856
Nov. 9, 2015 (KR) 10-2015-0156540

(51) Int. Cl. G06F 3/0484; H04M 1/725; G06Q 20/34; G06F 3/0481; G06Q 20/32; G06Q 20/24; H04W 4/14; G06F 3/0482

(52) U.S. Cl. CPC G06F 3/04847; H04W 4/14; H04M 1/72552; G06F 3/04842; G06F 3/0482; G06F 3/04845; G06F 3/0481; G06Q 20/3255; G06Q 20/24; G06Q 20/34

(57) ABSTRACT

A mobile device includes a communication module that is configured to receive at least one text message. The mobile device further includes a display module that is configured to display the at least one text message. The mobile device further includes a user interface module that is configured to detect a command that selects a specific text message from the at least one text message. The controller is configured to control the communication module, the display module, and the user interface module. The controller is further configured to identify, in response to the command, a different text message that is associated with a specific group that corresponds to the specific text message. The controller is further configured to display, on the display module, the different text message that is associated with the specific group and the specific text message.

### CROSS REFERENCE TO RELATED APPLICATIONS

Pursuant to 35 U.S.C. §119(a), this application claims the benefit of earlier filing date and right of priority to Korean Applications Nos. 10-2015-0155856, filed on Nov. 6, 2015, and 10-2015-0156540, filed on Nov. 9, 2015, the contents of which are hereby incorporated by reference herein in their entirety.

### FIELD

The present disclosure relates to a mobile device.

### BACKGROUND

A specific essential application is installed on a mobile device in a manner of being embedded or various applications can be downloaded to a memory of the mobile device. Generally, an application for processing a text message is basically loaded on every mobile phone almost.

Yet, various applications (e.g., WhatsApp, Kakao Talk, Facebook, other types of messaging related applications, etc.) substituted for the text message tend to be preferred recently.

Hence, a use rate of an existing text message (e.g., SMS, MMS, etc.) is rapidly falling. Yet, since significant information are still included in a text message in some cases, the demands for various tools capable of managing and accessing text messages efficiently and quickly are increasingly rising.

### SUMMARY

According to an innovative aspect of the subject matter described in this application, a mobile device includes a communication module that is configured to receive at least one text message; a display module that is configured to display the at least one text message; a user interface module that is configured to detect a command that selects a specific text message from the at least one text message; and a controller that is configured to: control the communication module, the display module, and the user interface module; identify, in response to the command, a different text message that is associated with a specific group that corresponds to the specific text message; and display, on the display module, the different text message that is associated with the specific group and the specific text message.

The mobile device may include one or more of the following optional features. The specific group is based on a display region where the user interface module detects the command for selecting the specific text message. The mobile device further includes a memory that is configured to store data that defines a mapping relationship between the specific group and the display region. The controller is configured to, based on a first display region of the specific text message being dragged to the different text message, associate both a text message that is received from a sender of the specific text message and a text message that is received from a sender of the different text message with the specific group. The controller is configured to, based on a second display region of the specific text message being selected over a preset time or under a preset pressure, associate a text message that is received on a date of receipt of the specific text message with the specific group. The first display region and the second display region do not overlap. The first display region corresponds to a display region that extends from a rightmost point of the specific text message to a reference center point on a horizontal axis. The second display region corresponds to a display region that extends from a leftmost point of the specific text message to the reference center point. The controller is configured to, based on a credit card payment related text message being selected from text messages that are associated with the specific group, display a different credit card payment related text message that is associated with a payment made within a preset time interval or at a preset location using payment information included in the credit card payment related text message.

According to another innovative aspect of the subject matter described in this application, a method of controlling a mobile device includes the actions of receiving at least one text message; displaying the at least one text message; detecting a command that selects a specific message from the at least one text message; in response to the command, identifying a different text message that is associated with a specific group that corresponds to the specific text message; and displaying the different text message that is associated with the specific group and the specific message.

The method may include one or more of the following optional features. The specific group is based on a region where the mobile device detects the command for selecting the specific text message. The actions further include associating both a text message that is received from a sender of the specific text message and a text message that is received from a sender of the different text message with the specific group based on a first display region of the specific text message being dragged to the different text message. The actions further include associating a text message received on a date of receipt of the specific text message with the specific group based on a second display region of the specific text message being selected over a preset time or under a preset pressure. The first display region and the second display region do not overlap. The first display region corresponds to a display region that extends from a rightmost point of the specific text message to a reference center point on a horizontal axis. The second display region corresponds to a display region that extends from a leftmost end point of the specific text message to the reference center point. The actions further include displaying a different credit card payment related text message that is associated with a payment made within a preset time interval or at a preset location using payment information included in the credit card payment related text message based on a credit card payment related text message being selected from text message that are associated with the specific group.

According to another innovative aspect of the subject matter described in this application, a mobile device includes a communication module that is configured to receive at least one text message; a display module that is configured to display the at least one text message; a memory that is configured to store type information of each of the at least one text message; and a controller that is configured to: control the communication module, the display module, and the memory; in response to a command that selects a text message of a first type, display, on the display module, a first input window that is configured for replying to the selected text message; and in response to a command that selects a text message of a second type, display, on the display module, a second input window that is configured for processing additional information that is related to the selected text message.

The mobile device may include one or more of the following optional features. The first input window and the second input window are displayed in different positions or in a same position. The memory is configured to store at least two message information types. The text message of the first type is associated with a sending phone number that corresponds to a mobile phone number. The text message of the second type is associated with a sending phone number that does not correspond to a mobile phone number. The memory is configured to store at least two message information types. The controller is configured to identify text messages of the first type and text messages of the second type based on a reply history. The controller is configured to, in response to the second input window receiving a specific command, display payment place information that is included in the text message of the second type as a map. The controller is configured to: identify at least one command that was previously inputted into the second input window; and display, on the display module, a selectable representation of the at least one command. The controller is configured to, in response to a command that selects the text message of the second type, identify information of a different text message of the second type and of the selected text message. The controller is configured to identify the different text message based on a name of a credit card or a bank being included in the selected text message, the different text message of the second type including the credit card or the bank name or includes a random credit card or bank name.

According to another innovative aspect of the subject matter described in this application, a method of controlling a mobile device includes the actions of receiving at least one text message; displaying the at least one text message; storing, in memory, type information of each of the at least one text message; in response to a command that selects a text message of a first type, displaying a first input window that is configured for replying to the selected text message; and in response to a command that selects a text message of a second type, displaying a second input window that is configured for processing additional information that is related to the selected text message.

One object of the subject matter described in this application is to provide a mobile device and controlling method thereof, by which a technique for sorting a multitude of text message by preset reference can be provided.

Another object of the subject matter described in this application is to provide a mobile device and controlling method thereof, by which an interface required for quickly managing a specific group of text messages in an integrated way can be provided.

Another object of the subject matter described in this application is to provide a mobile device and controlling method thereof, by which a solution for re-filtering text messages belonging to a specific group based on time or location can be provided.

Another object of the subject matter described in this application is to provide a mobile device and controlling method thereof, by which a solution for distinguishing a text message requiring a reply from a text message not requiring a reply can be provided.

Another object of the subject matter described in this application is to provide a mobile device and controlling method thereof, by which a scheme of designing an input window corresponding to a text message of a first type and an input window corresponding to a text message of a second type differently can be provided.

Further object of the subject matter described in this application is to provide a mobile device and controlling method thereof, by which a protocol related to a graphic image required for processing a text message of a specific type can be clearly defined.

### BRIEF DESCRIPTION OF THE DRAWINGS

FIG. 1A is a block diagram of an example mobile terminal.

FIGS. 1B and 1C are conceptual views of example mobile terminals, viewed from different directions.

FIG. 2 is a conceptual view of an example deformed mobile terminal.

FIGS. 3 and 4 are conceptual views of example wearable mobile terminals.

FIG. 5 is a block diagram of components of an example mobile device.

FIG. 6 is a diagram of a system having an example IA application loaded on a mobile device.

FIGS. 7A to 10B are diagrams of example interfaces on a mobile device during creation of a specific group for a random text message.

FIGS. 11A to 13C are diagrams for example processes for processing data related to first specific groups.

FIGS. 14A to 17C are diagrams for example processes for processing data related to second specific groups.

FIGS. 18A to 18D are diagrams for an example process for processing data related to an third specific group.

FIGS. 19A to 20D are diagrams for example processes for processing data related to fourth specific groups.

FIGS. 21A to 22C are diagrams for example processes for processing data related to fifth specific groups.

FIGS. 23A to 23C are diagrams for an example process for processing data related to a sixth specific group.

FIG. 24 is a flowchart for an example method of controlling a mobile device.

FIG. 25 is a block diagram of components of an example mobile device.

FIG. 26 is a diagram of a system having an example IA application loaded on a mobile device.

FIG. 27A and FIG. 27B are diagrams of example mobile devices configured to provide a stationary input window for all text messages.

FIGS. 28A to 28C are diagrams of example mobile devices providing an input window varying in accordance with a type of a text message.

FIG. 29 is a diagram of an example database proposing a determination reference for identifying a type of a text message.

FIGS. 30A to 30C are diagrams of an example input window for processing a payment related message among text messages of a specific type.

FIG. 31A and FIG. 36B are diagrams of example processes for processing example commands inputted to example input windows for processing payment information related messages among example text messages of a varying types.

FIG. 37 is diagram of an example process for processing an example command inputted to an example input window for processing an advertisement information related message among example text messages.

FIG. 38A and FIG. 38B are diagrams of example graphic images for switching an example first input window and an example input window for text messages to each other.

FIGS. 39A to 39C are diagrams of example graphic images for configuring an example text message related chat window.

FIG. 40 is a diagram of an example process for an example text message to enter a voice recognition step automatically instead of an input window.

FIG. 41 is a flowchart for an example method of controlling a mobile device providing an input window varying in accordance with a type of a text message.

### DETAILED DESCRIPTION

Description will now be given in detail with reference to the accompanying drawings. For the sake of brief description with reference to the drawings, the same or equivalent components may be provided with the same reference numbers, and description thereof will not be repeated. In some implementations, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the examples presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

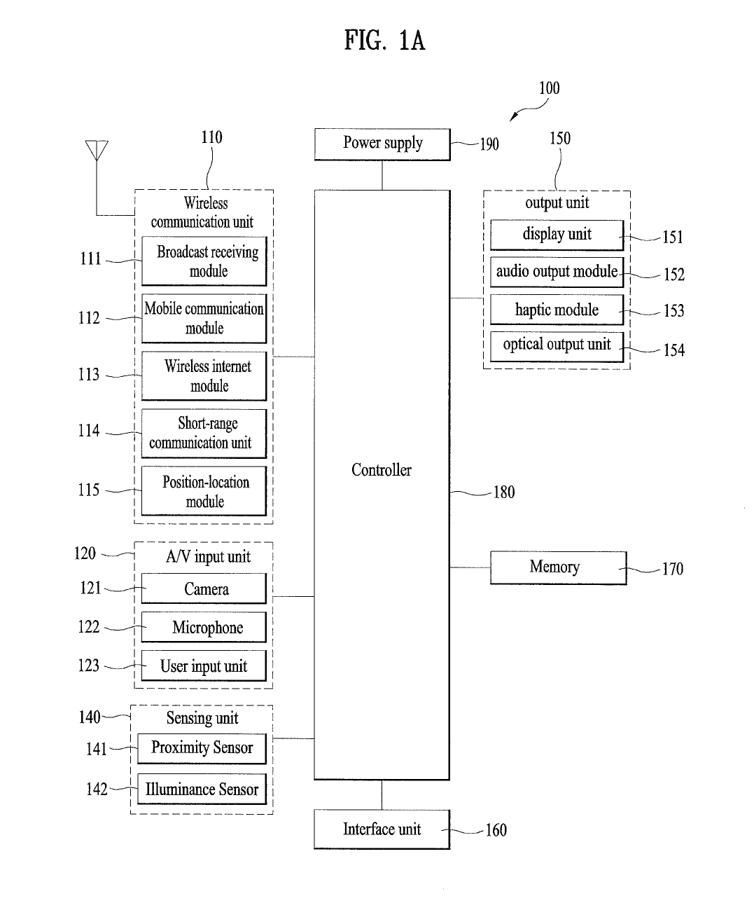

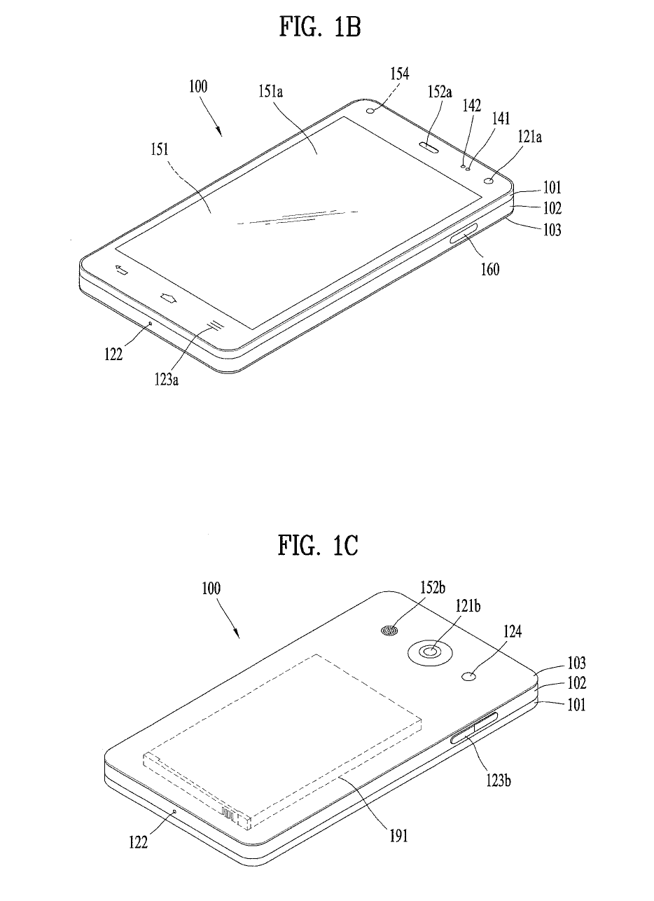

Reference is now made to FIGS. 1A-1C, where FIGS. 1A to 1C illustrate example mobile terminals.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

In some implementations, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and, in some implementations, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some implementations, two or more broadcast receiving modules 111 may be utilized to facilitate simultaneously receiving of two or more broadcast channels, or to support switching among broadcast channels.

The system which generates and transmits a broadcast signal and/or broadcast associated information, or a server which receives a pre-generated broadcast signal and/or broadcast associated information, sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in some implementations, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some implementations, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some implementations, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. In some implementations, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. In some implementations, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In some implementations, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In some implementations, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some implementations, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

In some implementations, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some implementations, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In some implementations, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In some implementations, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various examples described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In some implementations, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some implementations, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some implementations, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

In some implementations, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In some implementations, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Examples that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. In some implementations, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. In some implementations, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

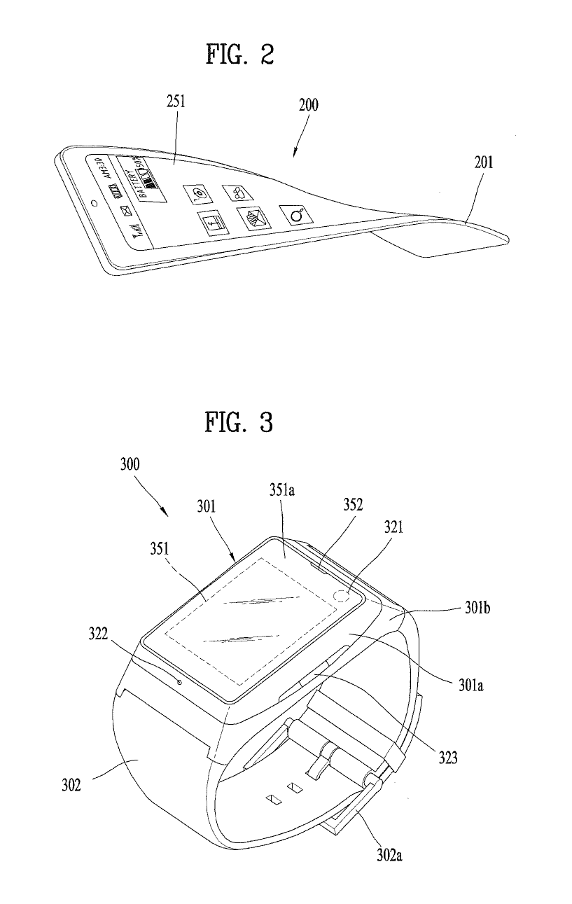

FIG. 2 illustrates an example mobile terminal. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In some implementations, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

In some implementations, the first state of the flexible display unit 251 may be a curved state (for example, a state of being curved from up to down or from right to left), instead of being in flat state. In some implementations, when an external force is applied to the flexible display unit 251, the flexible display unit 251 may transition to the second state such that the flexible display unit is deformed into the flat state (or a less curved state) or into a more curved state.

In some implementations, the flexible display unit 251 may implement a flexible touch screen using a touch sensor in combination with the display. When a touch is received at the flexible touch screen, the controller 180 can execute certain control corresponding to the touch input. In some implementations, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some implementations, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In some implementations, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 may transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

FIG. 3 illustrates an example watch-type mobile terminal 300. As illustrated in FIG. 3, the watch-type mobile terminal 300 includes a main body 301 with a display unit 351 and a band 302 connected to the main body 301 to be wearable on a wrist. In some implementations, mobile terminal 300 may be configured to include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some implementations, the display unit 351 includes a touch sensor so that the display unit can function as a touch screen. As illustrated, window 351a is positioned on the first case 301a to form a front surface of the terminal body together with the first case 301a.

The illustrated example includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In some implementations, the band 302 may be used for extending the performance of the antenna. For example, the band may include therein a ground extending portion electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

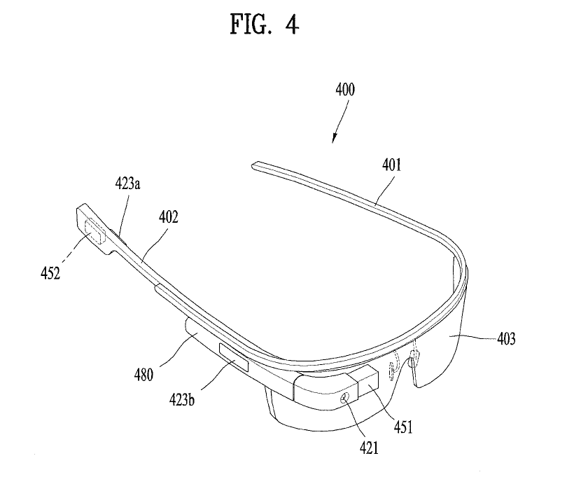

FIG. 4 illustrates an example glass-type mobile terminal 400. The glass-type mobile terminal 400 can be wearable on a head of a human body and provided with a frame (case, housing, etc.) therefor. The frame may be made of a flexible material to be easily worn. The frame of mobile terminal 400 is shown having a first frame 401 and a second frame 402, which can be made of the same or different materials. In some implementations, mobile terminal 400 may be configured to include features that are the same or similar to that of mobile terminal 100 of FIGS. 1A-1C.

The frame may be supported on the head and defines a space for mounting various components. As illustrated, electronic components, such as a control module 480, an audio output module 452, and the like, may be mounted to the frame part. Also, a lens 403 for covering either or both of the left and right eyes may be detachably coupled to the frame part.

The control module 480 controls various electronic components disposed in the mobile terminal 400. The control module 480 may be understood as a component corresponding to the aforementioned controller 180. FIG. 4 illustrates that the control module 480 is installed in the frame part on one side of the head, but other locations are possible.

The display unit 451 may be implemented as a head mounted display (HMD). The HMD refers to display techniques by which a display is mounted to a head to show an image directly in front of a user's eyes. In order to provide an image directly in front of the user's eyes when the user wears the glass-type mobile terminal 400, the display unit 451 may be located to correspond to either or both of the left and right eyes. FIG. 4 illustrates that the display unit 451 is located on a portion corresponding to the right eye to output an image viewable by the user's right eye.

The display unit 451 may project an image into the user's eye using a prism. Also, the prism may be formed from optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a realistic image or background using the display.

The camera 421 may be located adjacent to either or both of the left and right eyes to capture an image. Since the camera 421 is located adjacent to the eye, the camera 421 can acquire a scene that the user is currently viewing. The camera 421 may be positioned at most any location of the mobile terminal. In some implementations, multiple cameras 421 may be utilized. Such multiple cameras 421 may be used to acquire a stereoscopic image.

The glass-type mobile terminal 400 may include user input units 423a and 423b, which can each be manipulated by the user to provide an input. The user input units 423a and 423b may employ techniques which permit input via a tactile input. Typical tactile inputs include a touch, push, or the like. The user input units 423a and 423b are shown operable in a pushing manner and a touching manner as they are located on the frame part and the control module 480, respectively.

In some implementations, mobile terminal 400 may include a microphone which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may be closely adhered to the head when the user wears the mobile terminal 400 and vibrate the user's skull to transfer sounds.

A communication system which is operable with the variously described mobile terminals will now be described in more detail. Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (′UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system. A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (e.g., location technology that may be used in addition to or instead of GPS location technology) may alternatively be implemented. In some implementations, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. In some implementations, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In some implementations, the GPS module may acquire an accurate time together with three-dimensional speed information as well as the location of the latitude, longitude and altitude values from the location information received from the satellites.

Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal. Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

As previously described with regard to FIG. 1A, the mobile terminal may be configured to include short-range communication techniques such as Bluetooth™, Radio Frequency Identification (RFID), Infrared Data Association (IrDA), Ultra Wideband (UWB), ZigBee, Near Field Communication (NFC), Wireless USB (Wireless Universal Serial Bus), and the like.

A typical NFC module provided at the mobile terminal supports short-range wireless communication, which is a non-contactable type of communication between mobile terminals and generally occurs within about 10 cm. The NFC module may operate in one of a card mode, a reader mode, or a P2P mode. The mobile terminal 100 may further include a security module for storing card information, in order to operate the NFC module in a card mode. The security module may be a physical medium such as Universal Integrated Circuit Card (UICC) (e.g., a Subscriber Identification Module (SIM) or Universal SIM (USIM)), a secure micro SD and a sticker, or a logical medium (e.g., embedded Secure Element (SE)) embedded in the mobile terminal. Single Wire Protocol (SWP)-based data exchange may be performed between the NFC module and the security module.

In a case where the NFC module operates in a card mode, the mobile terminal may transmit card information on a general IC card to the outside. More specifically, if a mobile terminal having card information on a payment card (e. g, a credit card or a bus card) approaches a card reader, a short-range mobile payment may be executed. As another example, if a mobile terminal which stores card information on an entrance card approaches an entrance card reader, an entrance approval procedure may start. A card such as a credit card, a traffic card, or an entrance card may be included in the security module in the fool of applet, and the security module may store card information on the card mounted therein. Card information for a payment card may include any of a card number, a remaining amount and usage history, and the like. Card information of an entrance card may include any of a user's name, a user's number (e.g., undergraduate number or staff number), an entrance history, and the like.

When the NFC module operates in a reader mode, the mobile terminal can read data from an external tag. The data received from the external tag by the mobile terminal may be coded into the NFC Data Exchange Format defined by the NFC Forum. The NFC Forum generally defines four record types. More specifically, the NFC Forum defines four Record Type Definitions (RTDs) such as smart poster, text, Uniform Resource Identifier (URI), and general control. If the data received from the external tag is a smart poster type, the controller may execute a browser (e.g., Internet browser). If the data received from the external tag is a text type, the controller may execute a text viewer. If the data received from the external tag is a URI type, the controller may execute a browser or originate a call. If the data received from the external tag is a general control type, the controller may execute a proper operation according to control content.

In some cases in which the NFC module operates in a P2P (Peer-to-Peer) mode, the mobile terminal can execute P2P communication with another mobile terminal. In some implementations, Logical Link Control Protocol (LLCP) may be applied to the P2P communication. For P2P communication, connection may be generated between the mobile terminal and another mobile terminal. This connection may be categorized as a connectionless mode which ends after one packet is switched, and a connection-oriented mode in which packets are switched consecutively. For a typical P2P communication, data such as an electronic type name card, address information, a digital photo and a URL, a setup parameter for Bluetooth connection, Wi-Fi connection, etc. may be switched. The P2P mode can be effectively utilized in switching data of a small capacity, because an available distance for NEC communication is relatively short.

And, although some implementations are explained with an example for a case that a mobile terminal corresponds to a mobile terminal 100 shown in FIGS. 1a to 1c, the mobile terminal may correspond to one selected from the group consisting of a mobile terminal 200 of FIG. 2, a mobile terminal 300 of FIG. 3 and a mobile terminal 400 of FIG. 4. Moreover, the mobile terminal described in the present specification is interpreted as a meaning identical to a mobile device.

The mobile terminal described with reference to the foregoing drawings is applicable to a mobile device described in the following description with reference to the accompanying drawings.

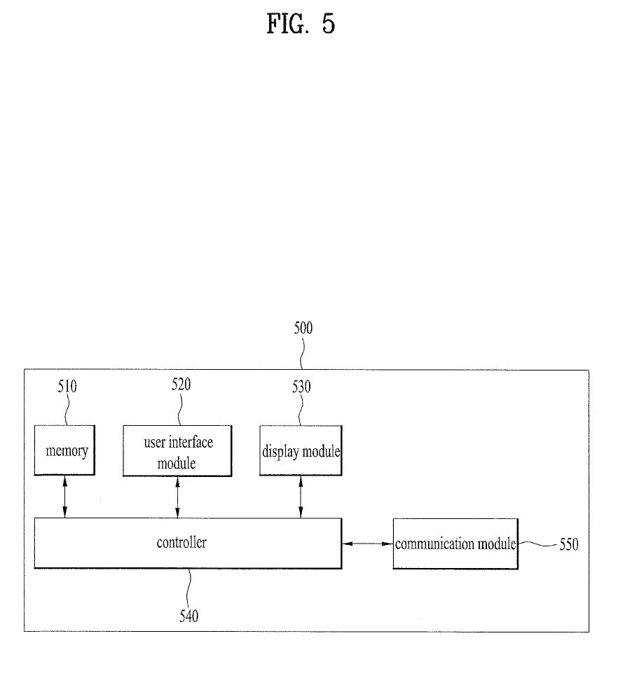

FIG. 5 illustrates example components of a mobile device.

Referring to FIG. 5, a mobile device 500 may include a memory 510, a user interface module 520, a display module 530, a controller 540, and a communication module 550.

The communication module 550 is designed to receive at least one text message and the display module 530 is designed to display the received at least one text message.

The user interface module 520 senses a command for selecting a specific text message from the displayed at least one or more text messages. The user interface module 520 may include a touch interface, a voice recognition interface, a mouse, a keypad, and the like for example.

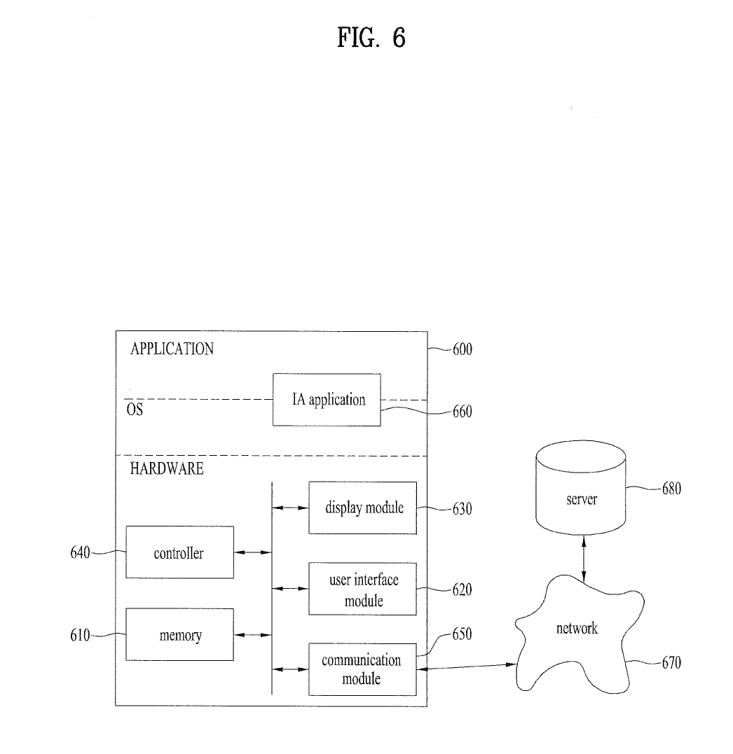

The controller 540 controls the communication module 550, the display module 520, and the user interface module 520. And, the controller 540 is implemented in form of an IA (intelligent agent) described with reference to FIG. 6 later, which pertains to the scope of the appended claims and their equivalents.

Particularly, in response to the sensed command, the controller 540 collects a different text message belonging to a specific group corresponding to the specific text message and is characterized in controlling the display module 530 to display both of the specific text message and the collected different message belonging to the specific group together.

In some implementations, the specific group varies in accordance with a region from which the command for selecting the specific text message is sensed. And, the memory 510 currently stores data for defining the mapping relation between the specific group and the sensed region. The database saved in the memory 510 shall be described in detail with reference to Table 1 and Table 2 later.

If a first region of the specific message is dragged to a different text message while touched, the controller 540 is designed to regard a text message received from the same sender of the specific text message and a text message received from the same sender of the different text message as belonging to the specific group by referring to the memory 510.

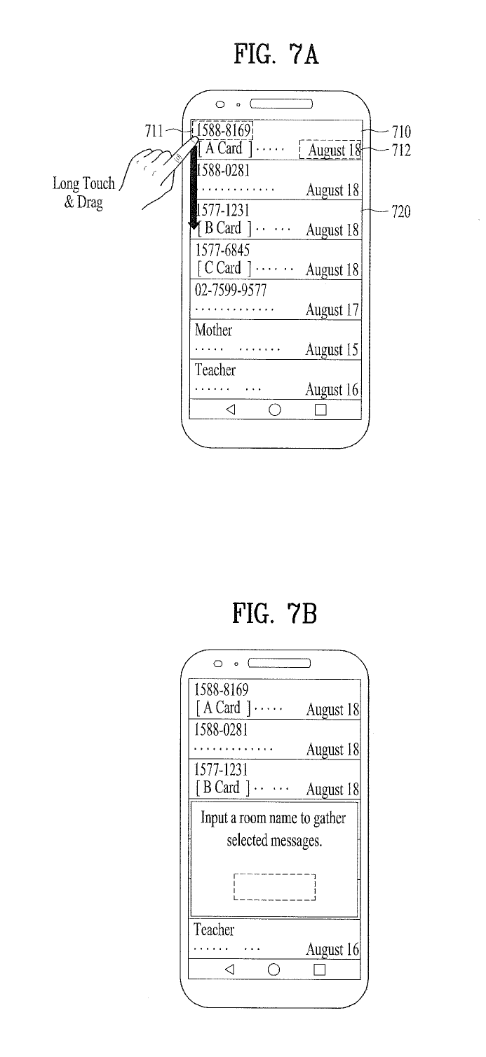

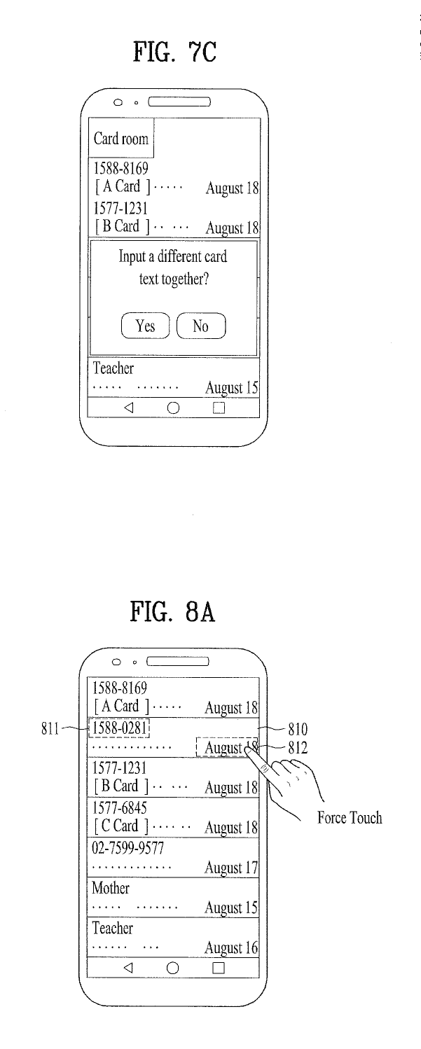

On the other hand, if a second region of the specific text message is touched over a preset time or a preset pressure, the controller 540 is designed to regard all text messages received on the same reception date of the specific text message as belonging to the specific group by referring to the memory 510. The first region shall be described in detail with reference to FIGS. 7A to 7C later, and the second region shall be described in detail with reference to FIG. 8A and FIG. 8B later.

The first region and the second region do not overlap each other. In some implementations, for example, the first region is designed to belong to a region ranging from a most right end point of the specific text message to a reference center point of a horizontal axis and the second region is designed to belong to a region ranging from a most left end point of the specific text message to the reference center point of the horizontal axis.

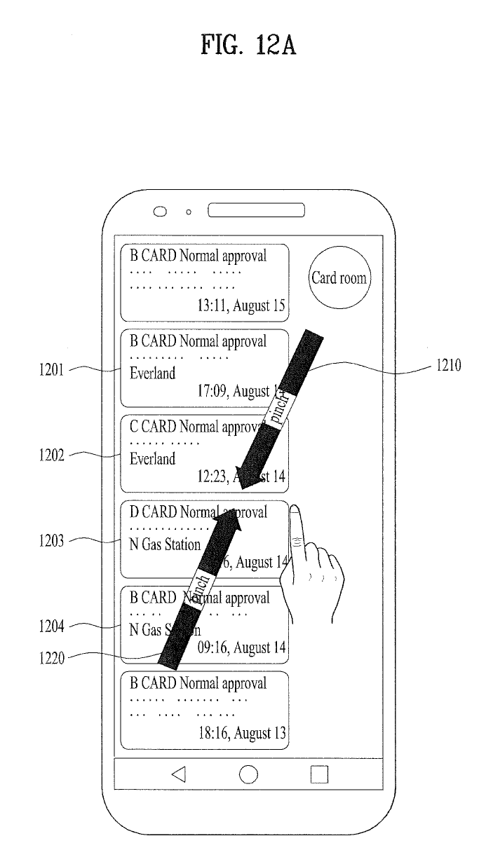

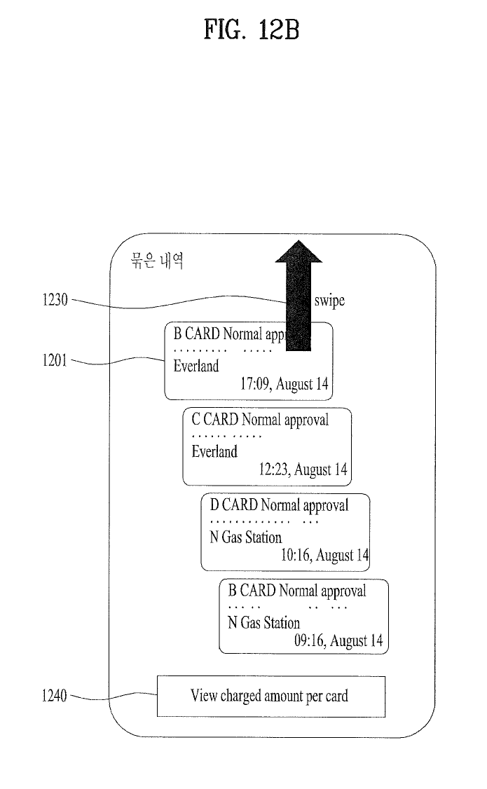

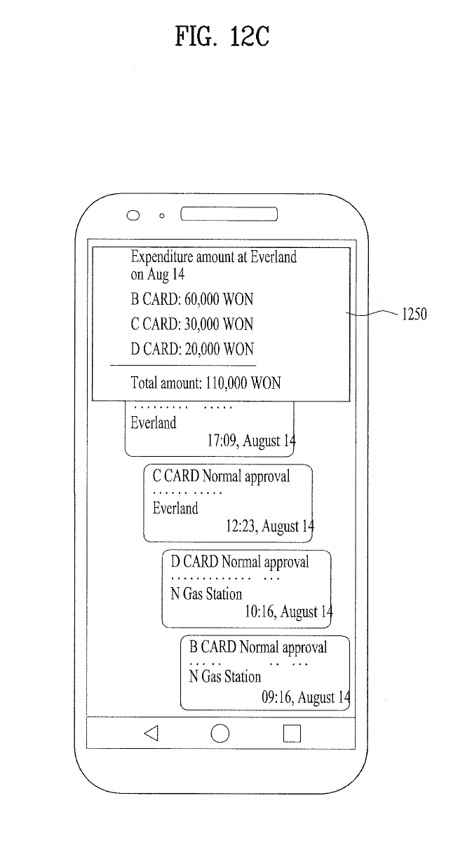

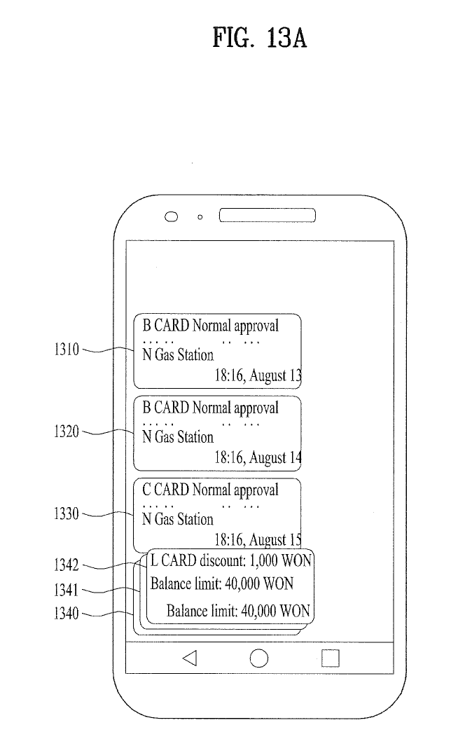

If a random credit card payment related text message is selected from the text messages belonging to the specific group, the controller 540 is designed to display a text message related to a different credit card used to make a payment in an interval of a preset time or an interval of a preset location using payment information included in the random credit card payment related text message. This shall be described in detail with reference to FIGS. 12A to 12C later.

In some implementations, a process for collecting a text message into a specific group manually or automatically may be necessary. This is performed through an IA (intelligent agent) and an application for performing an IA function is loaded on a separate memory or the memory 510 shown in FIG. 5. This is described in detail with reference to FIG. 6 as follows.

FIG. 6 illustrates an example system having IA application loaded on a mobile device.

First of all, in comparison with FIG. 5, a mobile device 600 shown in FIG. 6 may include a memory 610, a user interface module 620, a display module 630, a controller 640 and a communication module 650. Yet, unlike FIG. 6, the mobile device 600 accesses a server 680 (e.g., DB) through a network 670 (e.g., Internet) using the communication module 650. An IA application 660 may be necessary to receive additional information from an external database. Moreover, unlike FIG. 5, the mobile device 600 shown in FIG. 6 further includes the IA application 660 that can be included in an OS (operating system) layer or an application layer of the mobile device 600. In some implementations, the IA application 660 may include embedded software built in an operating system (OS) of the mobile device 600 or a downloadable software included in the application layer.

The IA or the IA application described in the present specification mainly plays a role in automatically controlling a text message related function (or application). For instance, the IA or the IA application has the concept of including random software or hardware configured to perform a job on behalf of a user for a specific purpose. In some implementations, as a trigger (e.g., designed to operate only if receiving a command for creating a text message into a specific group) for initiating an operation of the IA or the IA application is specifically designed, technical effects can be provided as follows. First of all, it is able to prevent the IA or the IA application from operating unnecessarily. Secondarily, efficiency in processing data can be improved. Thirdly, unnecessary battery consumption can be reduced.

FIGS. 7A to 7C illustrate an example mobile device creating a specific group for a random text message.

Referring to FIG. 7A, a received text message is displayed in a sorted state. Yet, according to a related art, a technique of grouping a plurality of text messages into a specific group has not been introduced yet. For instance, although text messages sent by several credit card companies coexist, there is a problem of having difficulty in managing and handling the coexisting text messages efficiently.

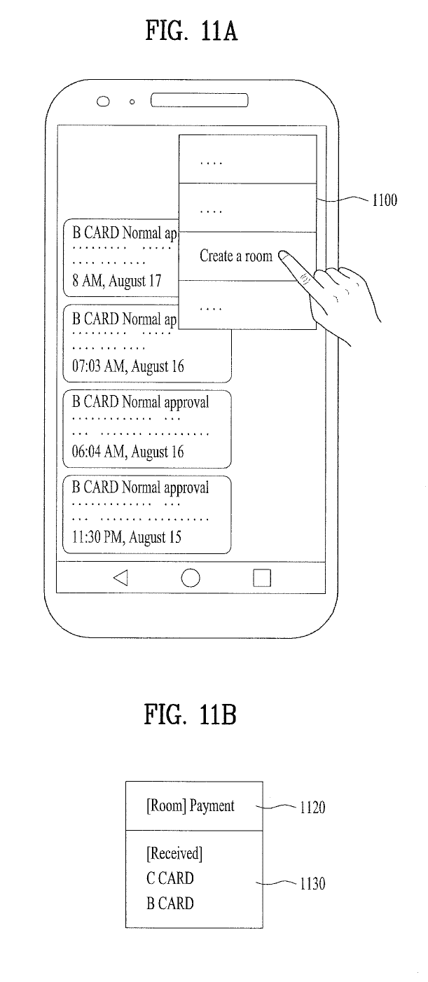

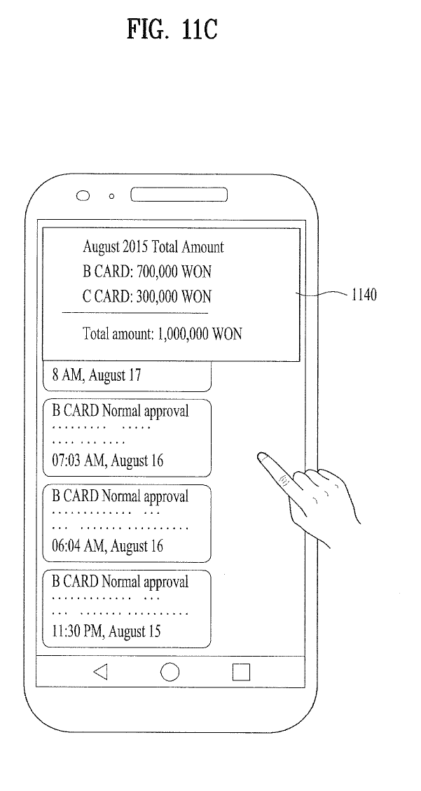

The technical idea is to propose a solution for collectively managing text messages having similar contents in a manner of inviting the text messages to a single room (or group). In some implementations, for instance, use histories of first and second credit cards are collected into a single group and then displayed. Hence, it is advantageous in that text messages sent by several credit card companies can be managed in a manner of being integrated. A process for processing a first specific group (e.g., credit card related text messages) shall be described in detail with reference to FIGS. 11 to 13 later.

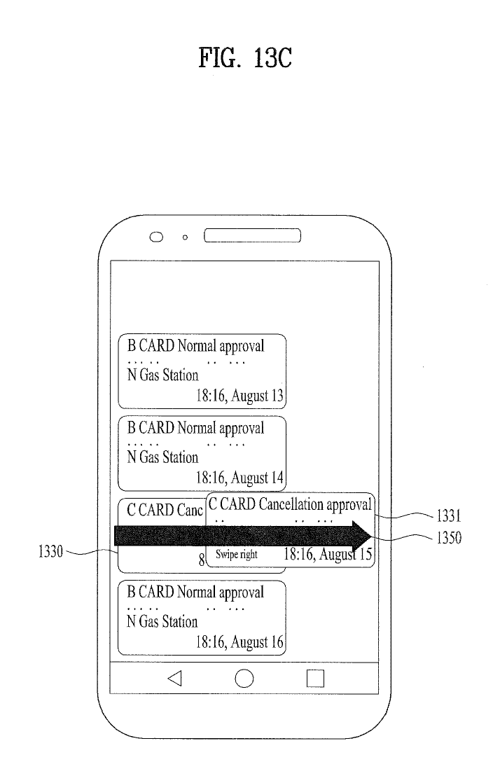

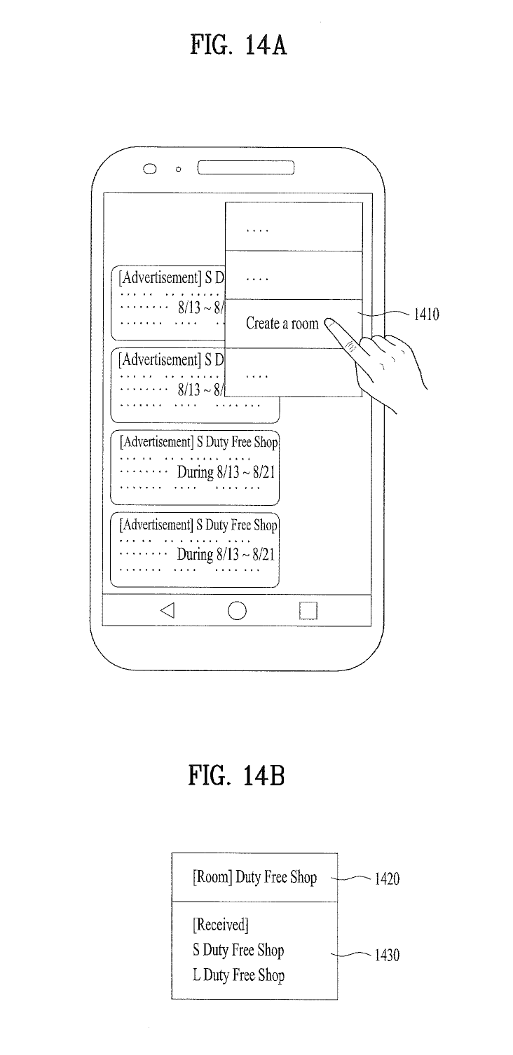

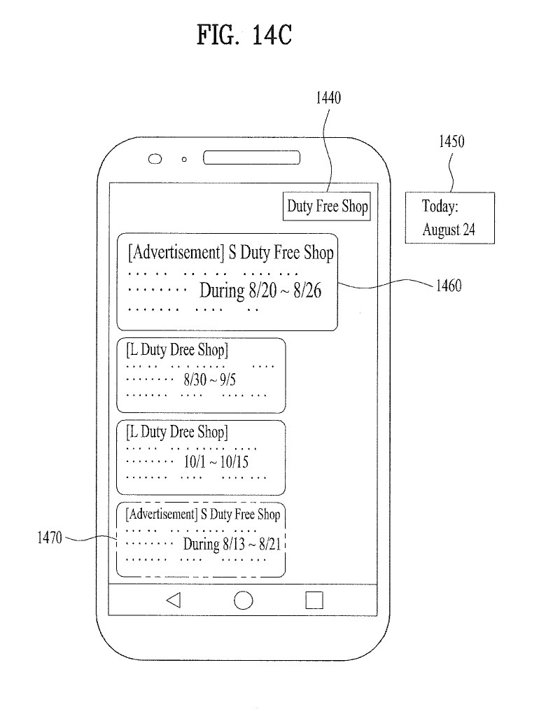

Furthermore, in case of a user travelling abroad, it may be necessary to separately manage duty free shop advertisement text messages. For instance, when a duty free shop advertisement text message is received, the received message may correspond to a spam message in viewpoint of the user. The reason for this is that the user is not planning an overseas trip for example. Yet, if the user plans an overseas trip thereafter, the received message becomes a necessary text message. A process for processing a second specific group (e.g., coupon related text messages) shall be described in detail with reference to FIGS. 14 to 17 later.

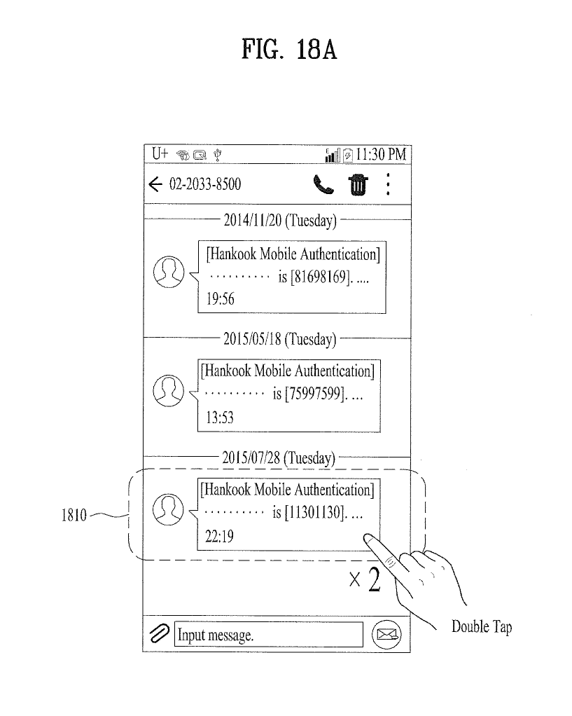

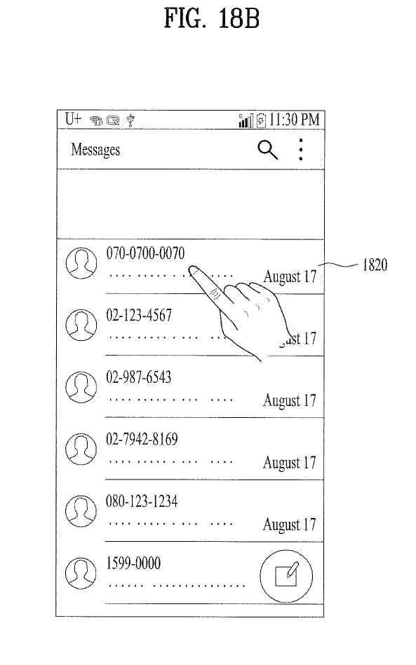

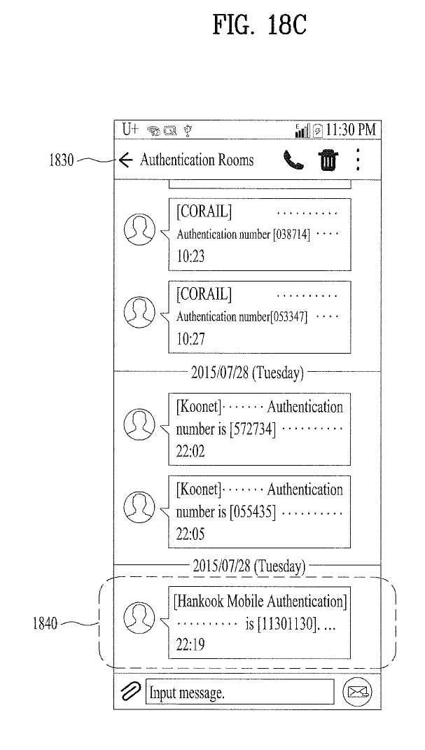

It may be necessary to separately manage authentication number related text messages required for making payments in Korea. A process for processing a third specific group (e.g., authentication number related text messages) shall be described in detail with reference to FIG. 18 later.

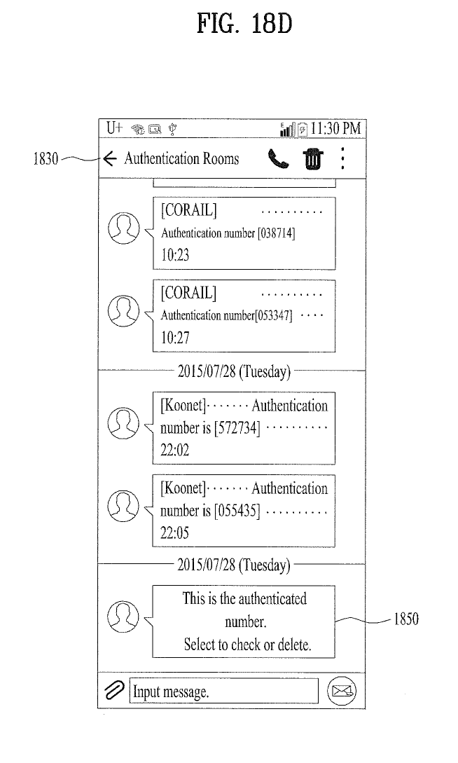

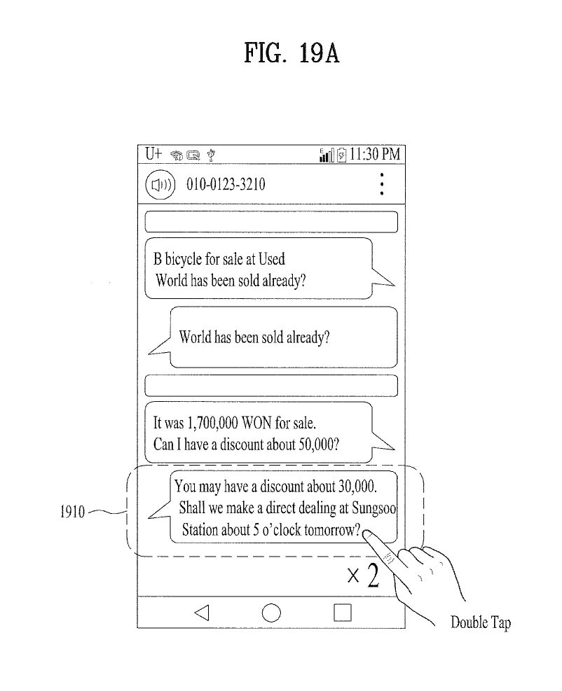

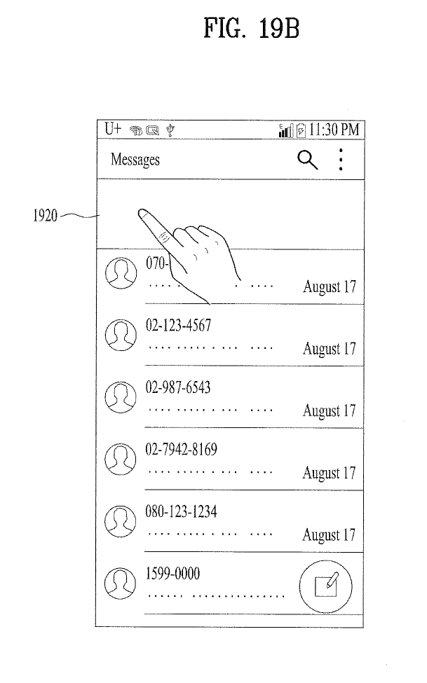

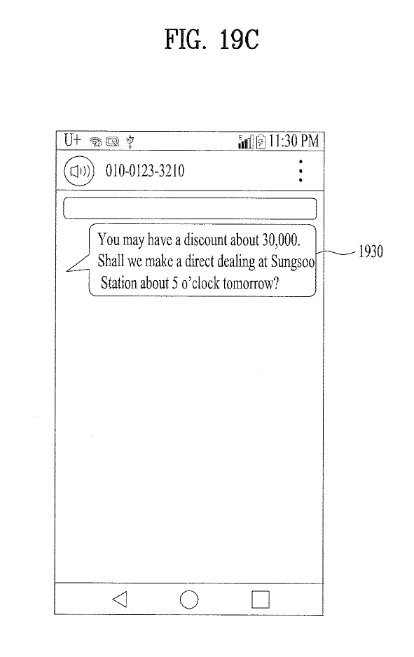

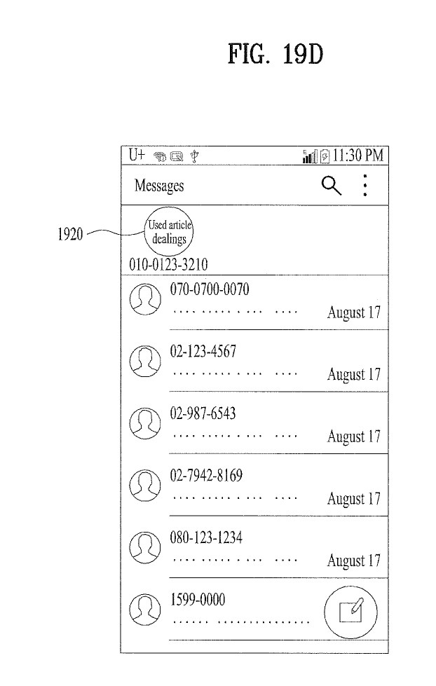

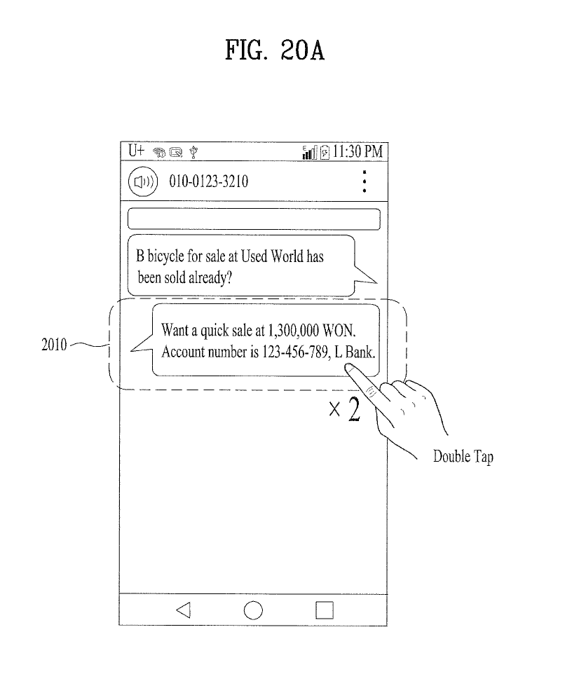

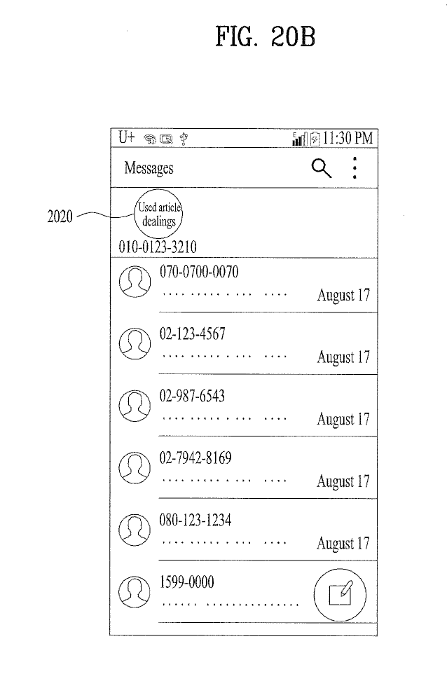

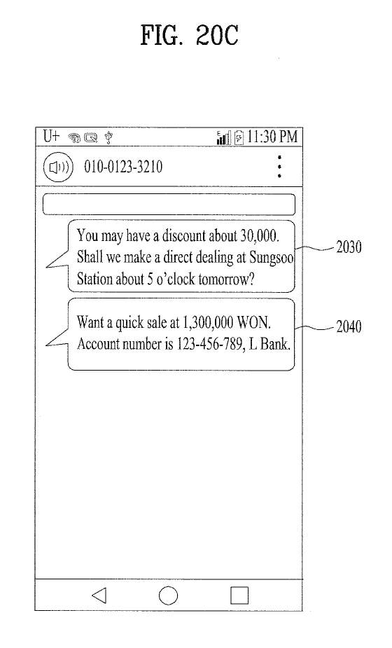

It may be necessary to separately manage text messages related to used article dealings. A process for processing a fourth specific group (e.g., text messages related to used article dealings) shall be described in detail with reference to FIG. 19 and FIG. 20.

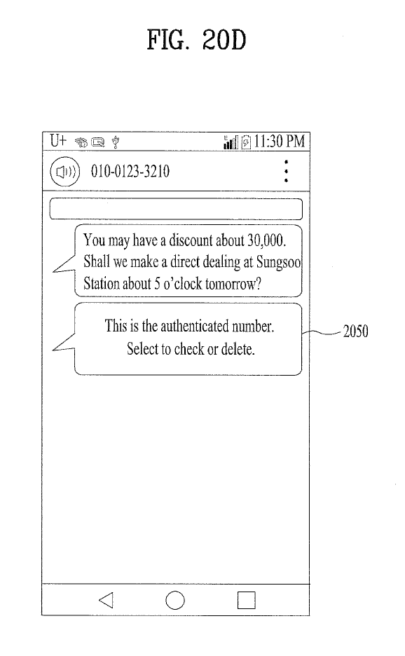

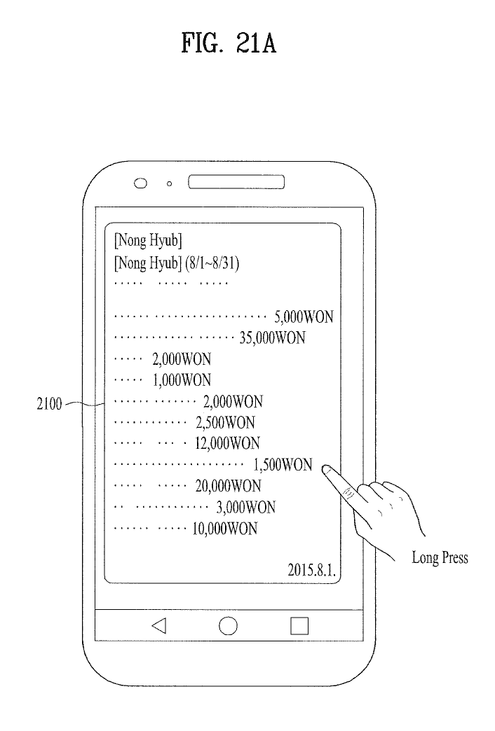

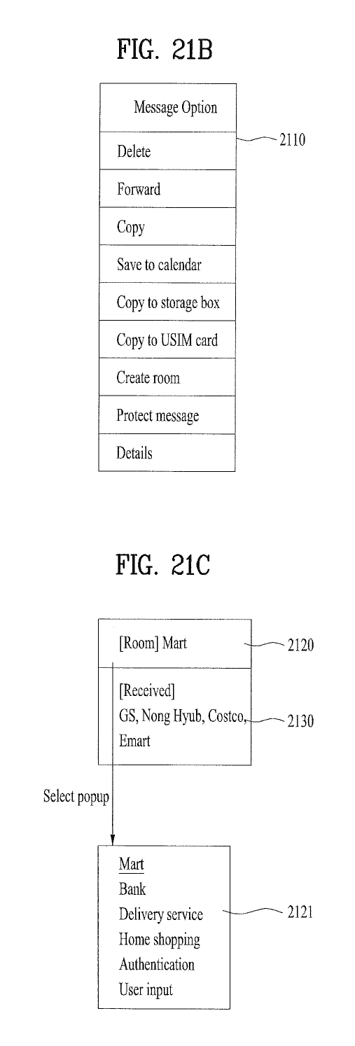

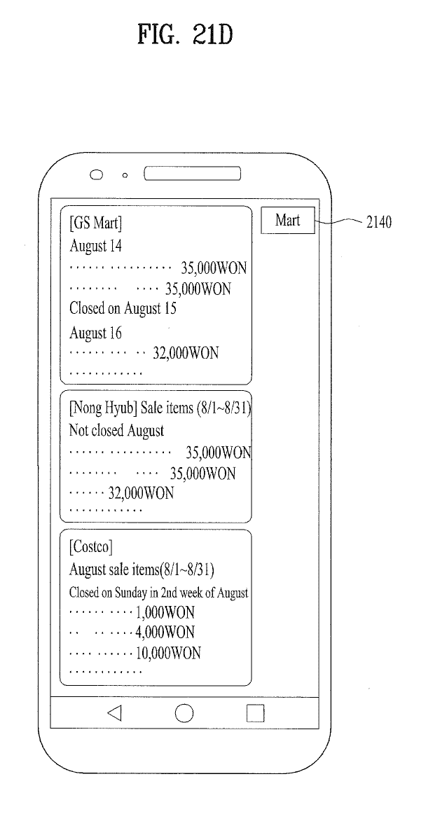

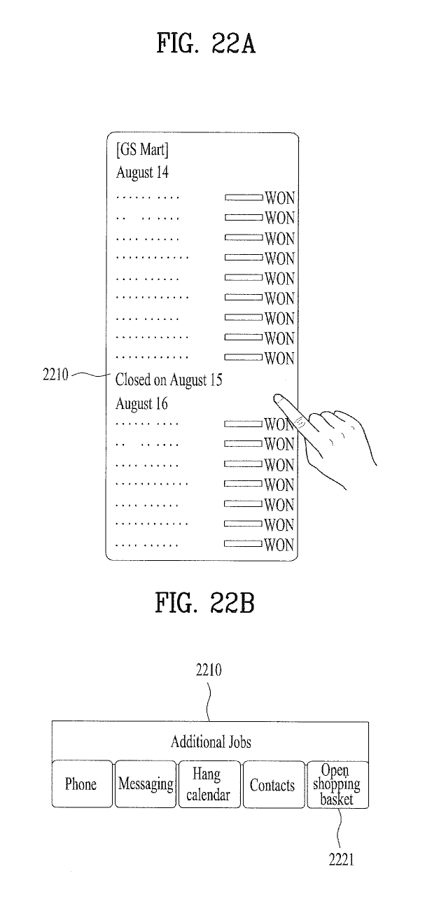

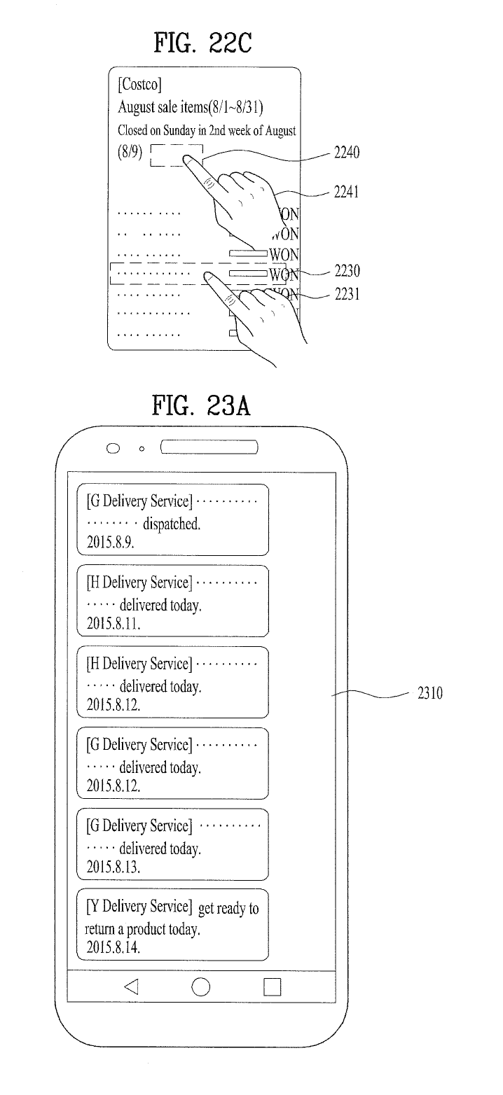

It may be necessary to separately manage advertisement related text messages sent by several marks (e.g., inter-mart price comparison, shortcut to a shopping basket, etc.). A process for processing a fifth specific group (e.g., text messages related to mart advertisements, etc.) shall be described in detail with reference to FIG. 21 and FIG. 22 later.

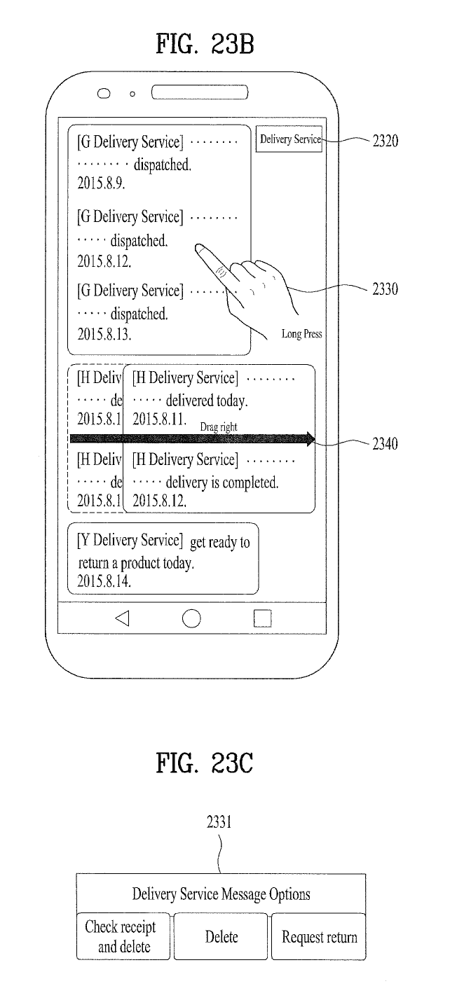

And, it may be necessary to separately manage text messages sent by a delivery service company (e.g., inter-mart price comparison, shortcut to a shopping basket, etc.). A process for processing a fifth specific group (e.g., distinction of reception/non-reception of a delivery product, deletion of a text message of a delivery confirmed product, etc.) shall be described in detail with reference to FIG. 23 later.

In some implementations, a region of a specific text message 710 is partitioned in a selectable first region 711 and a selectable second region 712. A solution for collecting a text message into a specific group by selecting the first region 711 shall be described in detail with reference to FIG. 7 in the following. And, a solution for collecting a text message into a specific group by selecting the first region 711 shall be described in detail with reference to FIG. 8 later.

First of all, referring to FIG. 7A, while the first region 711 of the random text message 710 is touched (e.g., a long touch corresponding to a touch kept over a preset time), if a drag to a different text message 720 is applied in continuation with the touch, a mobile device recognizes such actions as user's need for intending to create a specific group (or room). Hence, a data base shown in Table 1 should be established in a memory in advance.

TABLE 1

| Selection | Primary display | Secondary display |
|---|---|---|
| Long touch to | Display a guide message | Display a message for |
| a first region | for an input of a name | querying whether to |
| of first text | of a specific group | perform an integrated |
| message & drag | (or room) for | management for an |
| to a second | integrated management | addition of a third |
| text message | | text message |

Hence, referring to FIG. 7B, by referring to the database shown in Table 1 saved in the memory, the mobile device displays a guide message 730 for determining a name of a message room that is to be created to perform an integrated management of the two selected text messages 710 and 720.

Moreover, referring to FIG. 7C, by referring to the database shown in Table 1 saved in the memory, the mobile device displays a guide message 740 for querying whether to add a third text message to the created message room in addition to the selected two text messages 710 and 720.

Yet, unlike FIG. 7, if a first text message 710 is received from a first credit card company, all text messages received from the first credit card company are invited to the same room instead of simply inviting the two text messages to a single integrated management room. This can be implemented using an originating phone number of the first credit card. Likewise, if a second text message 720 is received form a second credit card company, all text messages received from the second credit card company are invited to the same room. Finally, if ‘yes’ is selected from the message 740, all text messages received the credit card companies are designed to be managed in the same room as well as the first credit card and the second credit card. Hence, there is a technical effect that a user does not have to move each text message to an integrated management room one by one.

FIG. 8A and FIG. 8B illustrate an example mobile device creating a specific group for a random text message.

First of all, in order to implement the example shown in FIG. 8, a database shown in Table 2 is saved in a memory of a mobile device.

TABLE 2

| | 1^{st} | 2^{nd} |
|---|---|---|
| | threshold | threshold |
| Selection | range | range |
| Force touch to a | Enlarge & | Collect all text |
| second region of | display | messages received |
| a first text message | | on a corresponding date |

Referring to FIG. 8A, a specific message 810 is partitioned into a first region 811 and a second region 812. A solution for creating a group (or room) for performing an integrated management on a plurality of texts messages by selecting the first region 811 has been described in detail with reference to FIG. 7 already.

If the second region 810 shown in FIG. 8A is touched with a weak force (e.g., within the first threshold range shown in Table 2), the mobile device displays the selected specific text message 810 in a manner of simply enlarging the selected text message 810 by referring to the database (DB) saved in the memory shown in Table 2.

On the other hand, if the second region 810 shown in FIG. 8A is touched with a strong force (e.g., within the second threshold range shown in Table 2), referring to FIG. 8B, the mobile device collects text messages 830 received on a same date 820 of the selected message and then displays the collected text message 830 only, by referring to the database (DB) saved in the memory shown in Table 2.

Moreover, if a random one 841 of the text messages 830 received on the same date is flicked in a right direction [840], the flicked text message 841 is automatically deleted from the corresponding room (or group). Of course, the text message 841 may continue to be displayed on a list of the entire text messages or may be deleted from the list as well.

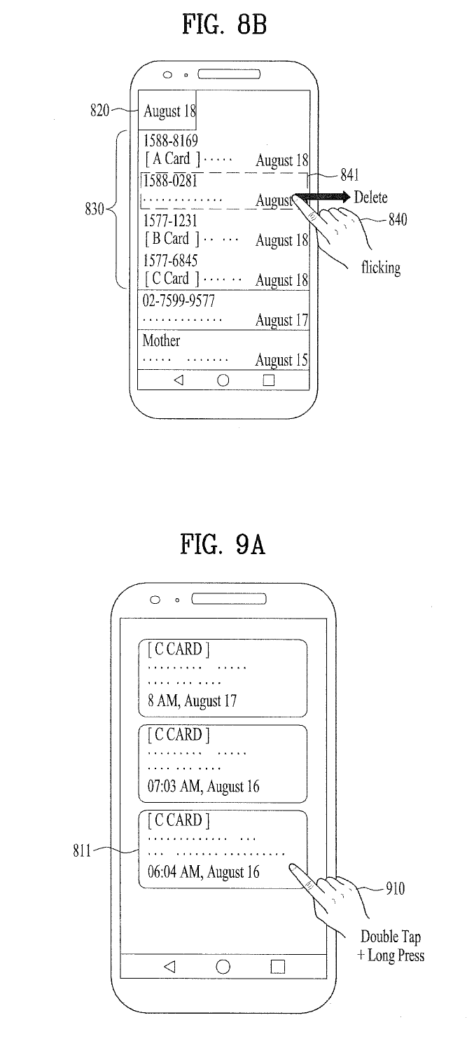

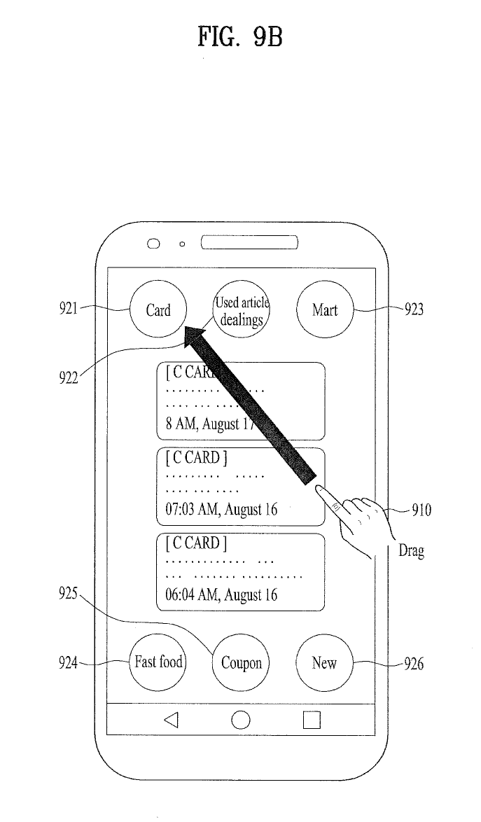

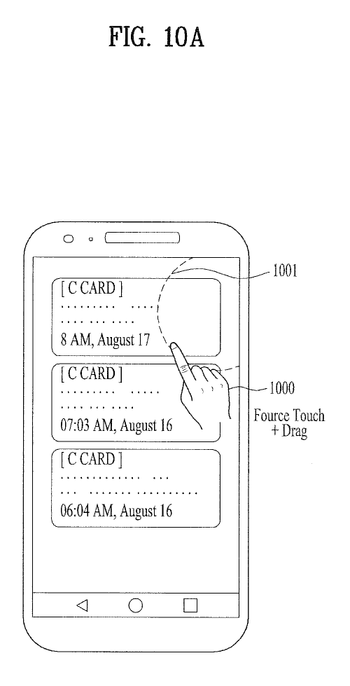

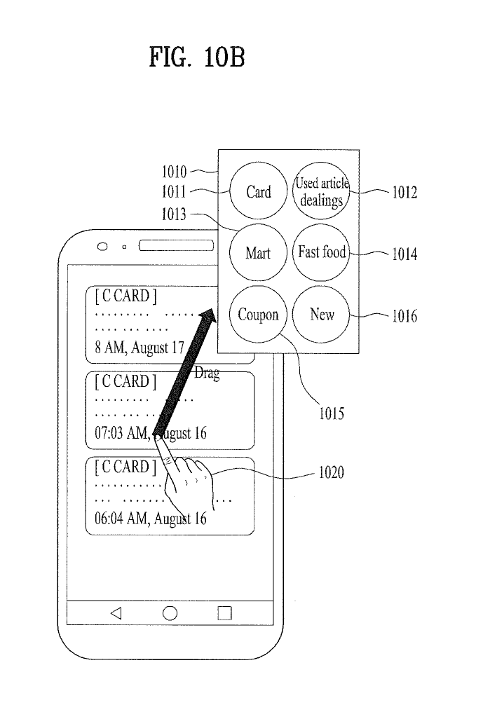

The example for creating a room (or group) for managing text messages in an integrate way has been described with reference to FIG. 7 or FIG. 8 already. Other examples for the same are described in detail with reference to FIG. 9 and FIG. 10 as follows.

FIG. 9A and FIG. 9B illustrate an example mobile device creating a specific group for a random text message.

Referring to FIG. 9A, if an input 910 is applied in a manner of double tapping a specific text message 900 and then touching the specific text message 900 over a preset time, a mobile terminal recognizes the 910 as a command for creating a separate room (or group) related to the specific text message 900.

Hence, referring to FIG. 9B, options 921 to 926 capable of confirming groups for managing the selected specific text message and other text messages are displayed. Like the example shown in FIG. 9B, after a user has dragged the specific message to a random group (or room) 921, it is advantageous for the user to check credit card related text messages at a time by selecting the card option 921 in the future.

FIG. 10A and FIG. 10B illustrate an example mobile device creating a specific group for a random text message.

Referring to FIG. 10, if a specific region 1001 of a mobile device is continuously touched (or dragged) [FIG. 10A], a folder 1010 capable of managing text messages in an integrated way is displayed [FIG. 10B]. In some implementations, the folder 101 provides primary categories 1011 to 1015 of the text messages in advance. If a category desired by a user does not exist, it is able to create a separate room 1016. Hence, a user 1020 can add a random text message to the category 1011 easily and conveniently. On the other hand, the specific region 1001 shown in FIG. 10A may be recognizable by a force touch instead of a simple touch. In some implementations, if a different function is designed to be implemented in response to a strength of a touch force (or pressure), it may pertain to another scope of the appended claims and their equivalents.

FIGS. 11A to 11C illustrate an example process for processing data related to a first specific group. In some implementations, the first specific group corresponds to text messages related to a credit card. In the following description, an implementation for collecting a use history of a first credit card and a use history of a second credit card is described with reference to FIG. 11.

Referring to FIG. 11A, if a random text message is selected, an option 1100 capable of creating a room (or group) for an integrated management is displayed. Of course, if a credit card related room is already created, the corresponding room is automatically entered.

If ‘create a room’ is selected from the option 1100 shown in FIG. 11A, referring to FIG. 11B, a sub option 1120 capable of editing a room name and a sub option 1130 capable of determining what kind of text messages will be collected are displayed. According to the example shown in FIG. 11B, assume that text messages related to Woori Card and text messages related to Shinhan Card are collected only. Those text messages are automatically collected using phone numbers or keywords (e.g., Woori Card, Shinhan Card, etc.) corresponding to the text messages.

Finally, referring to FIG. 11C, a resulting value 1140 resulting from separately collecting a total amount charged on each of the credit cards is displayed in a single room. Hence, in viewpoint of a user, text messages of each credit card and details of expenditure per credit card can be checked. A text message received after the room (or group) creation is automatically transferred to a corresponding room (name: payment). If a color of a text message received per credit card is set differently, it may pertain to another scope of the appended claims and their equivalents.

FIGS. 12A to 12C an example process for processing data related to a first specific group. In the following description, an implementation for checking an expenditure amount per place or date by combining a plurality of text messages in a payment room (e.g., first specific group) is described in detail with reference to FIG. 12.

Referring to FIG. 12A, a user can select a specific text message from text messages gathered in a payment room only. For instance, a touch gesture of pinches 1210 and 1220 for selecting first to fourth text messages 1201 to 1204 can be recognized.

Subsequently, referring to FIG. 12B, the text messages selected through the pinch touch gesture are separately displayed. If a text 1201 not desired by the user is included, the text 1201 can be deleted by being swiped in an upward direction. Thereafter, if ‘view an expenditure amount per card’ 1240 is selected, it is advantageous in that an expenditure amount per credit card company can be checked.

Finally, referring to FIG. 12C, a total amount 1250 charged on all credit cards on a specific date (or a charged range in a predetermined time) can be designed to be displayed. Alternatively, if amounts changed in a predetermined distance from a specific point (e.g., Everland) are displayed in a manner of being separately sorted using information on a charged place contained in a text message, it may pertain to another scope of the appended claims and their equivalents.

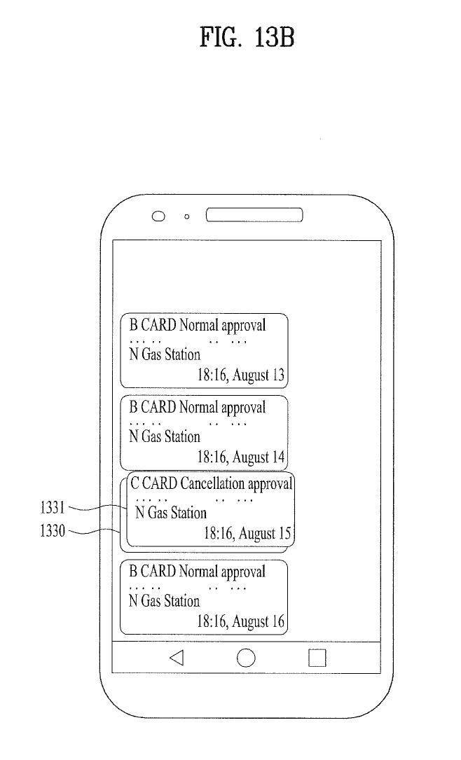

FIGS. 13A to 13C illustrate an example process for processing data related to a first specific group. In the following description, an implementation for displaying updates of information on a single transaction or a plurality of related text messages in a payment room (e.g., first specific group) in a manner of stacking the updates or the text messages on each other is described with reference to FIG. 13.

Referring to FIG. 13A, text messages 1310, 1320 and 1330 related to credit card payments are independently displayed, whereas advertisement related text messages 1340 to 1342 unrelated to a payment in direct are displayed in a manner of being stacked on each other (or, overlapping each other). The reason for this is that a user does not need to check them instantly.

Moreover, after a payment of a same product has been made, it may happen that the corresponding transaction is cancelled. If so, since the payment and the cancellation are separately displayed according to a related art, it causes a problem that a user has difficulty in checking which payment is cancelled. To solve such a problem, referring to FIG. 13B, a text message 1330 related to an approval for a payment of a random specific product and a text message 1331 related to a cancellation of a payment of a product identical to the specific product are displayed in a manner of being stacked on each other. Hence, there is a technical effect that a user can easily confirm that the cancellation has been made after the payment.

Finally, referring to FIG. 13C, if the hidden text message 1330 is designed to be checked through a swipe action in order to display one of the stacked text messages 1330 and 1331, it pertains to another scope of the appended claims and their equivalents.

FIGS. 14A to 14C illustrate an example process for processing data related to a second specific group. In some implementations, the second specific group corresponds to text messages related to coupons. In the following description, an implementation for saving duty free shop advertisement related text messages usable for an overseas trip to a memory is described in detail with reference to FIG. 14.

Referring to FIG. 14, if ‘create a room’ is selected from an option 1410 [FIG. 14A], a sub option 1420 capable of editing a room name and a sub option 1430 for determining what kind of text messages will be collected are displayed [FIG. 14B]. In FIG. 14B, assume that text messages related to Shilla Duty Free Shop and text messages related to Lotte Duty Free Shop are collected only. In some implementations, the text messages are automatically collected using a phone number or keyword (e.g., Shilla, Lotte) corresponding to a text message.

Finally, referring to FIG. 14C, after a benefit period included in a text message has been automatically recognized in a single room 1440, a text message 1460 having a less benefit period is situated on a top end with reference to a current date 1450 and a font size is set large. On the other hand, a text message 1470 having an expired benefit period is situated on a bottom end and is set to be dimmed. Hence, it is advantageous in that a user can easily check a text message according to priority.

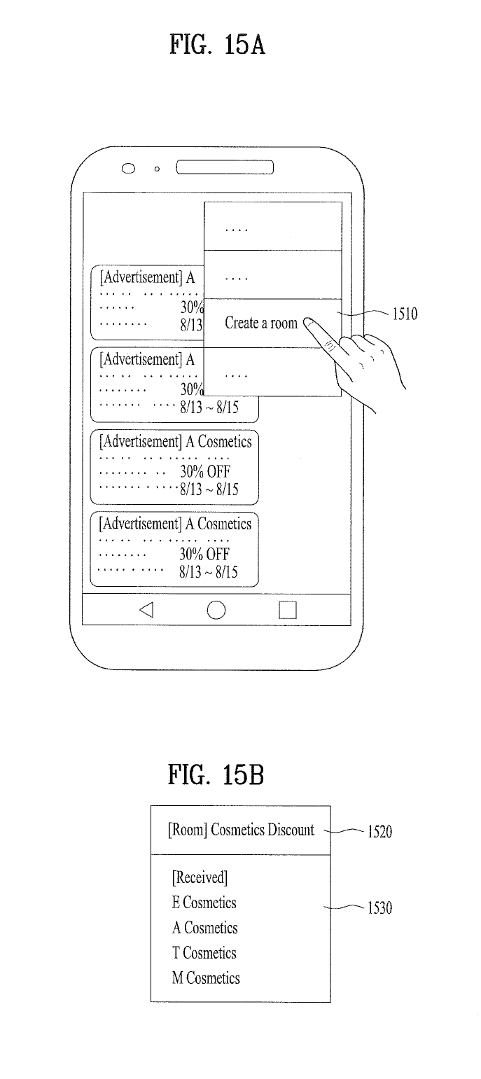

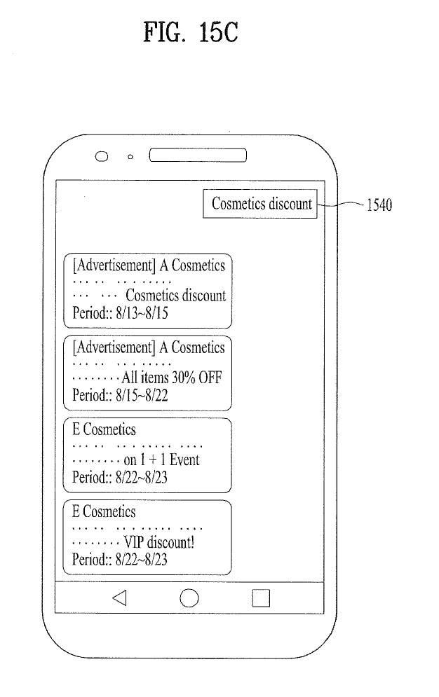

FIGS. 15A to 15C illustrate an example process for processing data related to a second specific group. In the following description, an implementation for sorting a text message related to discount information of a specific product (e.g., cosmetics) separately and then saving the sorted text message to a memory is described with reference to FIG. 15.

Referring to FIG. 15, if ‘create room’ is selected from an option 1510 [FIG. 15A], a sub option 1520 capable of editing a room name and a sub option for determining what kind of text messages will be collected are displayed [FIG. 15B]. In FIG. 15B, assume that text messages related to Inis*ree, text messages related to *litaum, text messages related to The*aceshop, or text messages related to Mi* are collected only. In some implementations, the text messages are automatically collected using a phone number or keyword corresponding to a text message.

Finally, referring to FIG. 15C, specific cosmetics related text messages including a corresponding keyword are listed and displayed in a single room 1540. If discount benefit information per brand of cosmetics are collected and displayed by being sorted in order of period, it pertains to another scope of the appended claims and their equivalents. Moreover, a text having an expired benefit period can be designed to be automatically deleted by recognizing a current date.

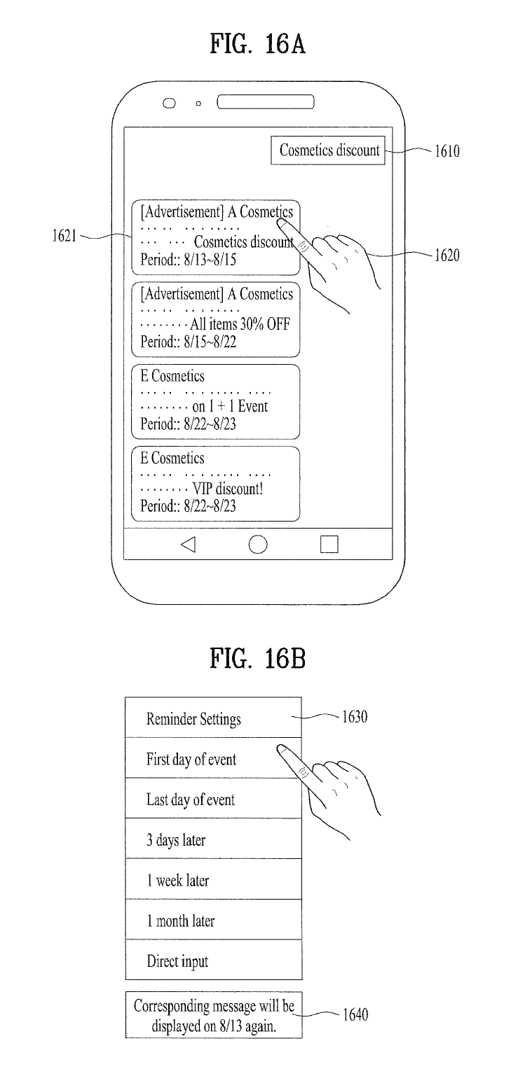

FIG. 16A and FIG. 16B illustrate an example process for processing data related to a second specific group to. An implementation for providing a reminder service of a coupon related text message is described in detail with reference to FIG. 16 as follows.

Referring to FIG. 16, if a touch 1620 is applied to a specific text message 1621 among text messages arranged in a cosmetics discount related group (or room) 1610 over a preset time [FIG. 16A], an option 1630 capable of setting a REMINDER is provided [FIG. 16B]. Hence, a user can reset the REMINDER for one of an event start date, an expiration of a predetermined period, and the like or may reset the REMINDER in a manner that a user directly inputs a desired timing point. Of course, When the REMINDER is not set yet, if there is a text message unchecked for a predetermined period, the REMINDER service is automatically provided again before an end of an event (e.g., 3 days ago).

If the reminder setting 1630 is performed, a guide message 1640, which is provided to guide when the REMINDER will be displayed, is displayed.

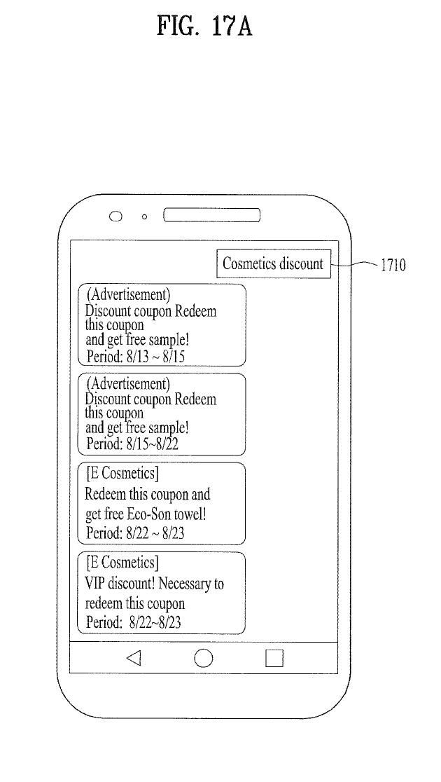

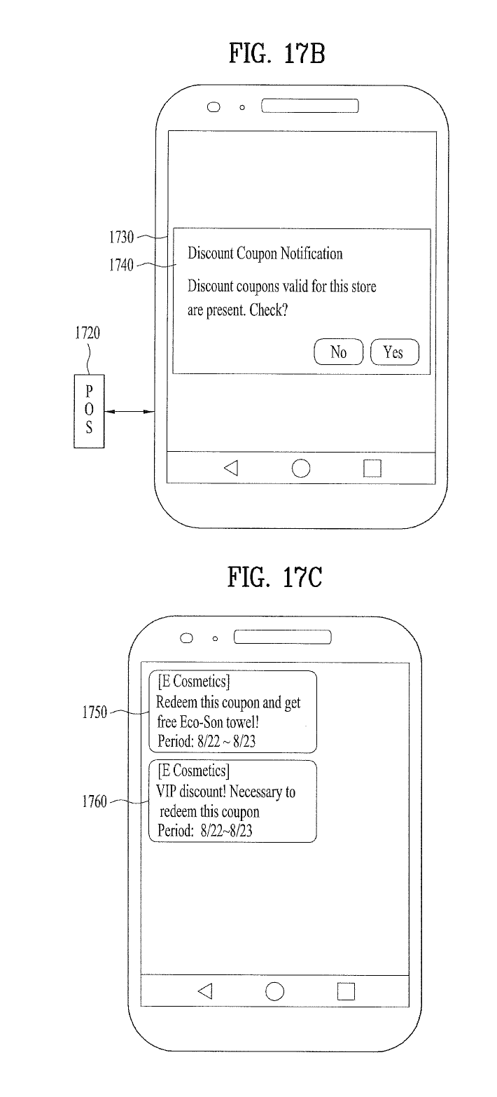

FIGS. 17A to 17C illustrate an example process for processing data related to a second specific group. An implementation for automatically displaying a coupon related text message corresponding to a payment made at a specific store after receiving coupon related text messages is described in detail with reference to FIG. 17 as follows.

Referring to FIG. 17A, assume that a cosmetics coupon/discount related specific group (or room) 1710 is created. If a communication connection or a contact for making a payment is established between a mobile device 1730 and a POS device 1720 of a specific store, referring to FIG. 17B, a message 1740 indicating a presence of a related text message currently stored is displayed.

For instance, if a place for selling a specific product named ‘Inisfree’ is recognized, referring to FIG. 17C, text messages 1750 and 1760 for purchasing Inisfree products at reduced prices are sequentially displayed.

FIGS. 18A to 18D illustrate an example process for processing data related to a third specific group to. In some implementation, the third specific group corresponds to text messages related to authentication numbers used for user authentications. An implementation for managing various authentication numbers into a single group (or room) is described in detail with reference to FIG. 18 as follows.

Referring to FIG. 18A, if an authentication number related text message 1810 is double tapped, it is recognized as a need for intending to the selected text message to a different message window. Hence, referring to FIG. 18B, it is possible to select a message window 1820 to which the selected text message will be added.

Hence, referring to FIG. 18C, it can be confirmed that a selected text message has been added to an authentication number room 1830. After the authentication number included in the selected message has been used, referring to FIG. 18D, a guide message 1850, which is provided to indicate that the authentication has been completed or to delete the selected text message, is displayed.

FIGS. 19A to 19D illustrate an example process for processing data related to a fourth specific group. In some implementation, the fourth specific group corresponds to text messages related to used article dealings. An implementation for managing text messages related to used article dealings as ‘group’ in a single room is described in detail with reference to FIG. 19 as follows.

Referring to FIG. 19A, if a specific text message 1910 related to used article dealings is selected (e.g., double tapped), it is recognized as a need for adding the selected text message to a different message window. Subsequently, referring to FIG. 19B, it is possible to select a message window to which the selected text message will be added. For instance, assume that a blank region 1920 located at a top end portion is selected.

If so, referring to FIG. 19C, it can be observed that a selected specific message 1930 is included in a separate room. Referring to FIG. 19D, it can be observed that a room 1940 including text messages related to used article dealings only is created at a top end portion. This corresponds to a shortcut function.

FIGS. 20A to 20D illustrate an example process for processing data related to a fourth specific group. On the assumption of the description with reference to FIG. 19, an implementation for accessing a created specific room is described in detail with reference to FIG. 20 as follows.

Referring to FIG. 20, after a text message 2010 desired to be included in a specific group has been selected (e.g., double tapped) [FIG. 20A], if a specific group 2020 to which the selected text message will be included is selected [FIG. 20B], it can be observed that the selected text message 2040 shown in FIG. 20A is displayed in the room including the used article dealings related text messages only together with the existing text message 2030 [FIG. 20C]. Furthermore, after a deposit or remittance according to the used article deal has been completed, referring to FIG. 20D, a corresponding message 2050 is automatically deleted.

FIGS. 21A to 21D illustrate an example process for processing data related to a fifth specific group. In some implementations, the fifth specific group corresponds to text messages related to marts. An implementation for collecting and displaying text messages related to mart advertisements and then distinguishing the text messages per mart from each other using different graphic images (e.g., colors) is described in detail with reference to FIG. 21 as follows.

Referring to FIG. 21, if a mart advertisement related text message 2100 is touched over a preset time [FIG. 21A], a text message related option 2110 is displayed [FIG. 21B]. In some implementations, the option ‘create a room’ is added.

Moreover, referring to FIG. 21C, an option 2120 capable of editing a name of a room for collecting text messages of a specific group and an option capable of determining a reference of the specific group are additionally provided. A recommended list 2121 of room names for the name of the room may be designed to be displayed.

If a user selects ‘Mart’ as the name of the room and phone numbers of text messages are set as GS, Nong Hyub and the like with reference to keywords [FIG. 21C], a mart room 2140 is automatically created and text messages received from the respective marts are collected and displayed in the mart room 2140 [FIG. 21D]. Of course, if colors of the text messages received from the marts are set different, respectively, it pertains to the scope of the appended claims and their equivalents.

FIGS. 22A to 22C illustrate an example process for processing data related to a fifth specific group. An implementation for performing a price comparison and shopping using text messages related to mart advertisements is described in detail with reference to FIG. 22 as follows.

A text message received from GS Mart shown in FIG. 22A and a text message received from Costco can be simultaneously displayed in a single room.

Referring to FIG. 22, if a text message 2210 is selected (e.g., double tapped) [FIG. 22A], options 2220 for doing additional jobs are displayed [FIG. 22B]. After a price comparison has been performed by selecting ‘open a shopping basket’ 2221, it is able to give an order in direct.

In some implementations, referring to FIG. 22C, if a long touch 2231 is applied to a specific item 2230, the corresponding specific item is moved to a shopping basket. On the other hand, if a long touch 2241 is applied to a blank region 2240, all products included in the text message are moved to the shopping basket.

In some implementations, if an item of a lowest price is recommended by comparing all text messages included in a mart room with each other or an item of a next lowest price is recommended in case of a specific mart that is closed, it pertains to the scope of the appended claims and their equivalents.

FIGS. 23A to 23C illustrate an example process for processing data related to a sixth specific group. In some implementations, the sixth specific group corresponds to text messages related to delivery services. An implementation for deleting a delivery service related text message, checking a receipt, and checking a delivery status per product is described in detail with reference to FIG. 23 as follows.

Referring to FIG. 23A, a screen 2310 having random text messages listed thereon is displayed. In doing so, if a delivery service related text message is selected, referring to FIG. 23B, a delivery service room (or group) 2320 is automatically created. It is possible to collect delivery service related text messages using a fact that a keyword or an originating phone number is matched. In some implementations, if text messages are rearranged per company, it pertains to the scope of the appended claims and their equivalents.

If a specific delivery service related text message is touched over a preset time, options 2331 shown in FIG. 23C are displayed. If the option ‘check a receipt and delete’ is selected, delivery service related text messages corresponding to a delivered product are collectively deleted and the receipt of the corresponding product is processed as confirmed. In some implementations, a receipt confirmation information is designed to be forwarded through an order site. On the If the option ‘delete’ is selected, the corresponding text message is deleted only and a receipt confirmation is designed not to be performed. If the option ‘request return’ is selected, a return request is designed to be directly made to a delivery service company.

If a random delivery service related text message is swiped in a right direction, as shown in FIG. 23B, information indicating that the delivery completion is confirmed is forwarded to an order site, a corresponding delivery service company, or the like through Internet. Yet, the corresponding text may not be deleted or may be deleted according to user's additional settings.

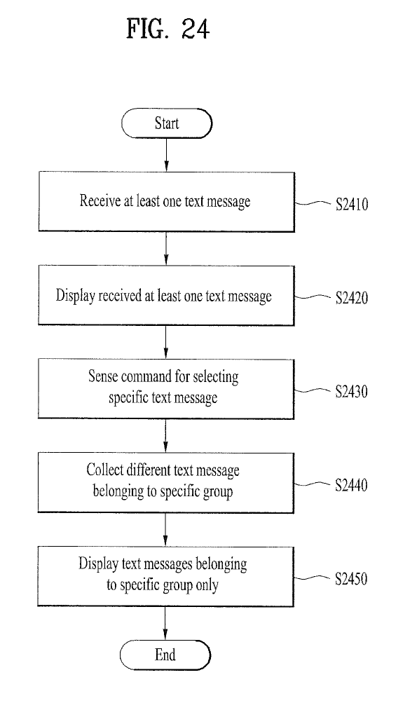

FIG. 24 illustrates an example method of controlling a mobile device.

Referring to FIG. 24, a mobile device receives at least one or more text messages [S2410]. The mobile device displays the received at least one or more text messages [S2420]. And, the mobile device senses a command for selecting a specific text message from the displayed at least one or more text messages [S2430].

In response to the sensed command, a different text message belonging to a specific group corresponding to the specific text message is collected [S2440]. And, both of the collected different text message belonging to the specific group and the specific text message are controlled to be displayed together [S2450].

In some implementations, for example, the specific group is characterized in varying in accordance with a region from which the command for selecting the specific text message is sensed.

In the step S2450, if a drag to the different text message is applied while a first region of the specific text message is touched, a text message received from the same sender of the specific text message and a text message received from the same sender of the different text message are regarded as belonging to the specific group. Moreover, in the step S2450, if a second region of the specific text message is touched over a preset time or a preset pressure (or force), all text messages received on the same reception date of the specific text message are regarded as belonging to the specific group.

As mentioned in the foregoing description with reference to FIG. 7 and FIG. 8, the first region and the second region do not overlap each other. The first region belongs to a region ranging from a most right end point of the specific text message to a reference center point of a horizontal axis. And, the second region belongs to a region ranging from a most left end point of the specific text message to the reference center point of the horizontal axis.

Finally, the step S2450 further comprises the step of if a random credit card payment related text message is selected from the text messages belonging to the specific group, displaying a different text message related to a different credit card used to make a payment in an interval of a preset time or an interval of a preset location using payment information included in the random credit card payment related text message.

In some implementations and with reference to FIGS. 1 to 24, it may bring a technical effect that a text message can be managed efficiently and accessed quickly.

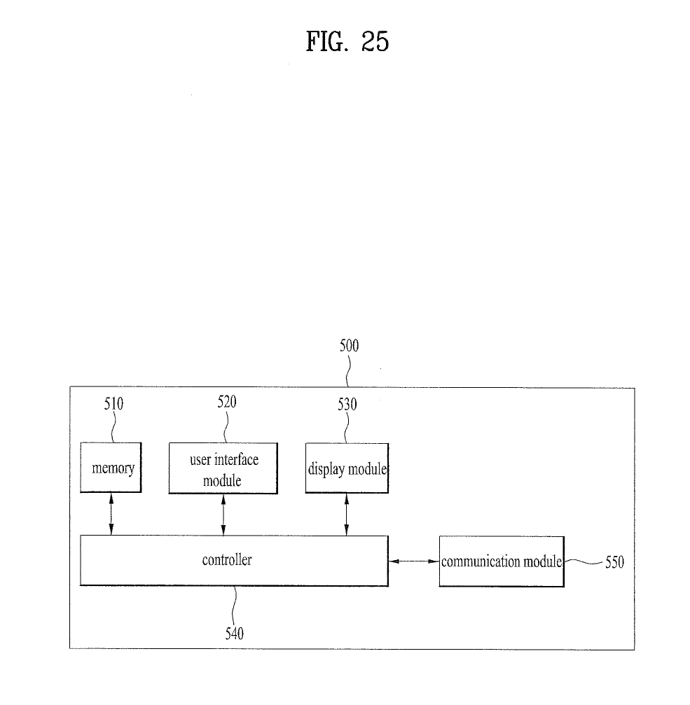

Besides, implementations for differently designing an input window corresponding to a text message of a first type and an input window corresponding to a text message of a second type shall be described in detail with reference to FIG. 25 as follows. In some implementations, one of the examples described with reference to FIGS. 1 to 24 can be combined with one of the following examples described with reference to FIG. 25 to implement the mobile device, which pertains to the scope of the appended claims and their equivalents.

FIG. 25 illustrates example components of a mobile device.

Referring to FIG. 25, a mobile device 500 may include a memory 510, a user interface module 520, a display module 530, a controller 540, and a communication module 550.

The communication module 550 plays a role in receiving at least one text message and the display module 530 plays a role in displaying the received at least one text message.

The memory 510 stores type information of each of the received at least one text message. And, the controller 540 plays a role in controlling the communication module 550, the display module 530 and the memory 510.

In response to a command for selecting a text message of a first type, the controller 540 controls the display module 530 to display a first input window capable of replying to the selected text message, with reference to the memory 510. The selection command may be received through the user interface module 520 and may be designed on the basis of a touch for example.

In response to a command for selecting a text message of a second type, the controller 540 controls the display module 530 to display a second input window capable of processing additional information related to the selected text message, with reference to the memory 510. Meanwhile, the selection command may be received through the user interface module 520 and may be designed on the basis of a touch for example.

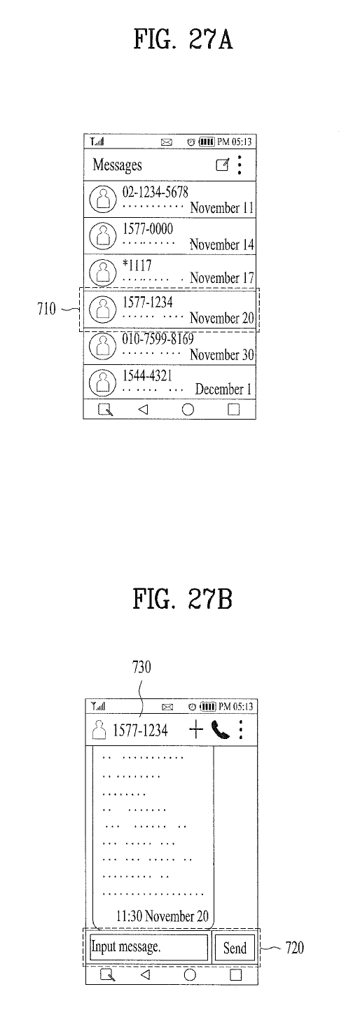

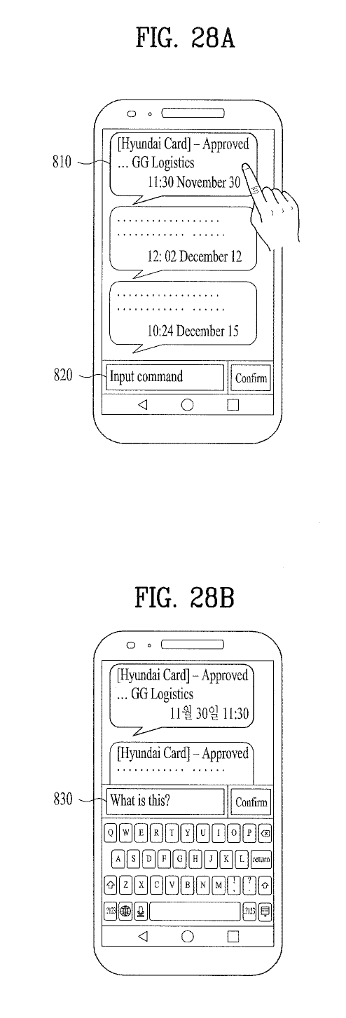

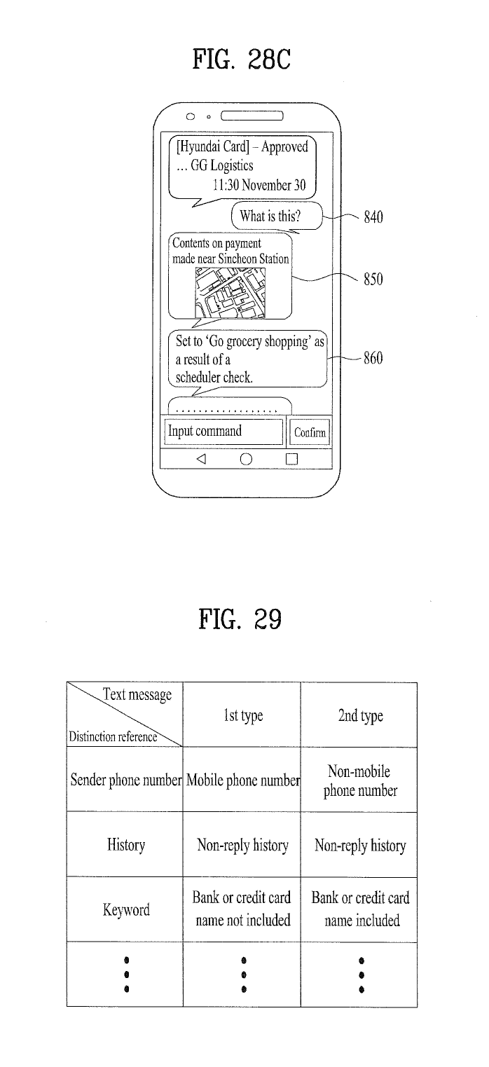

The first input window and the second input window are characterized in being displayed at different locations, respectively or at the same location. The first and second input windows shall be described in detail with reference to FIG. 27 and FIG. 28 later.

The memory 510 currently stores at least two message information types. For instance, the text message of the first type is characterized in that a phone number of a sender corresponds to a mobile phone number, whereas the text message of the second type is characterized in that a phone number of a sender is not a mobile phone number. Alternatively, the text message of the first type and the text message of the second type may be determined according to a reply history. This shall be described in detail with reference to FIG. 29 later.

In response to a specific command inputted to the second input window, the controller 540 is characterized in displaying a payment place information included in the text message of the second type in form of a map. This shall be described in detail with reference to FIG. 32 later.

The controller 540 is designed to collect at least one command having a history of being inputted to the second input window and to display an option capable of selecting the collected at least one command, by referring to the memory 510. This shall be described in detail with reference to FIG. 33 later.

In response to a command for selecting the text message of the second type, the controller 540 collects information on a different text message of the same type as well as information on a selected specific text message. This shall be described in detail with reference to FIG. 34 later.

Moreover, if a name of a credit card or bank is included in the selected specific text message, the different text message of the same type may mean that a name of the same credit card or bank is included only or that a name of a random credit card or bank is included. This shall be described in detail with reference to FIG. 34 later.

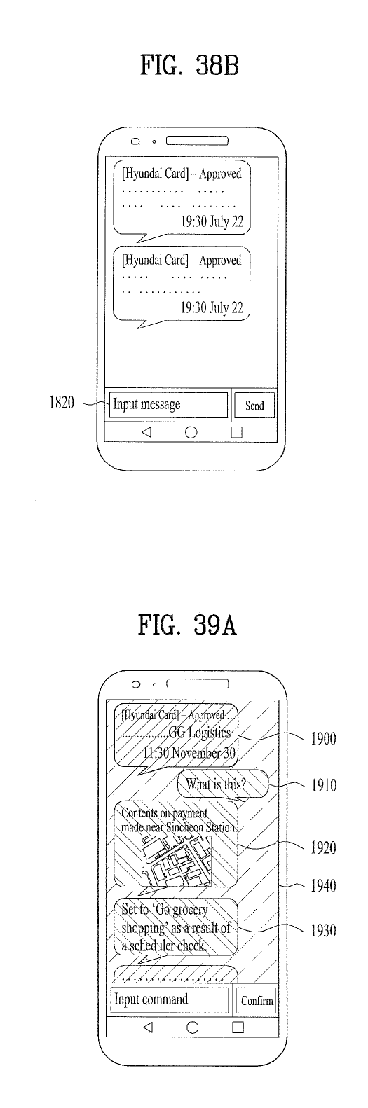

In response to a command for selecting the text message of the second type, the controller 540 displays a first input window capable of replying to the selected text message in the first place. Subsequently, in response to a command for continuously processing the first input window in a specific direction, the controller 540 displays a second input window capable of processing additional information related to the selected text message instead of the first input window. This shall be described in detail with reference to FIG. 38 later.

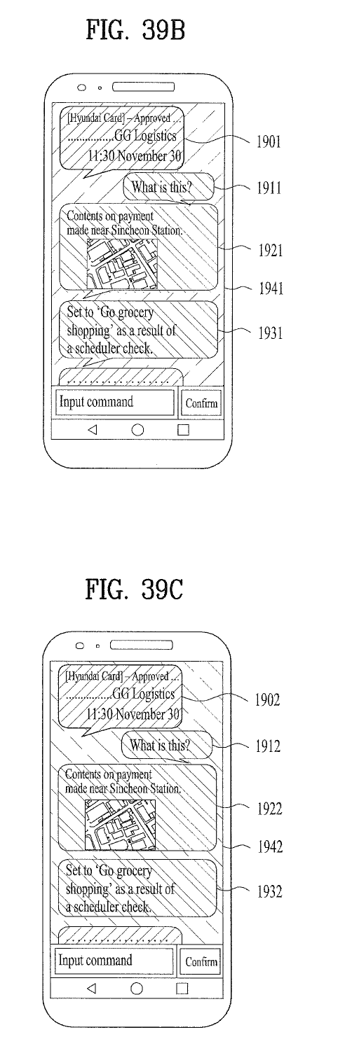

The controller 540 displays the text message of the second type as a first graphic image. The controller 540 displays a specific command inputted to the second input window as a second graphic image. And, the controller 540 displays a result value generated in response to the specific command as a third graphic image. In some implementations, the first to third graphic images includes colors, respectively and are designed to be displayed in sequence. This shall be described in detail with reference to FIG. 39 later.

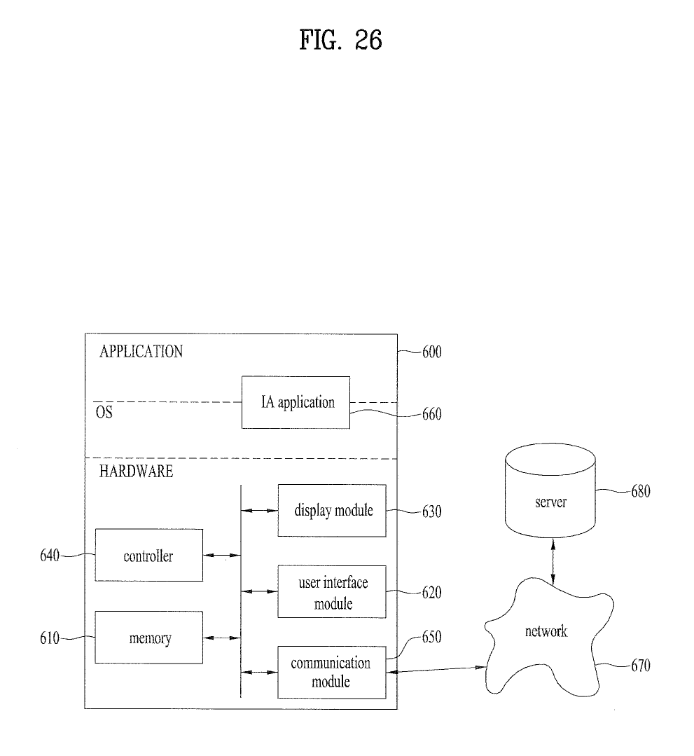

A process for individually sorting or categorizing types of text messages may be necessary. This is performed through an IA (intelligent agent) and an application for performing an IA function is loaded on a separate memory or the memory 510 shown in FIG. 25. This is described in detail with reference to FIG. 26 as follows.

FIG. 26 illustrates an example system having IA application loaded on a mobile device.

Referring to FIG. 26, in comparison with the former mobile device shown in FIG. 25, a mobile device 600 includes a memory 610, a user interface module 620, a display module 630, a controller 640 and a communication module 650. Yet, unlike FIG. 25, the mobile device 600 accesses a server 680 (e.g., DB) through a network 670 (e.g., Internet) using the communication module 650. An IA application 660 may be necessary to receive additional information from an external database. Moreover, unlike FIG. 5, the mobile device 600 shown in FIG. 6 further includes the IA application 660 that can be included in an OS (operating system) layer or an application layer of the mobile device 600. In some implementations, the IA application 660 may include an embedded software built in an operating system (OS) of the mobile device 600 or a downloadable software included in the application layer.

The IA or the IA application described in the present specification mainly plays a role in automatically controlling a text message related function (or application). For instance, the IA or the IA application has the concept of including random software or hardware configured to perform a job on behalf of a user for a specific purpose. In some implementations, as a trigger (e.g., designed to operate only if receiving a text message) for initiating an operation of the IA or the IA application is specifically designed, technical effects can be provided as follows. First of all, it is able to prevent the IA or the IA application from operating unnecessarily. Secondarily, efficiency in processing data can be improved. Thirdly, unnecessary battery consumption can be reduced.

FIG. 27A and FIG. 27B illustrate an example mobile device configured to provide a stationary input window for all text messages.

First of all, according to a related art, there is a replay input window unnecessary for an information message (e.g., a message related to a payment information, a message related to an advertisement information, etc.).

Referring to FIG. 27A, all received messages are provided as a list. In doing so, if a reply impossible text message 710 shown in FIG. 27A is selected, referring to FIG. 27B, an input window 720 for a reply is still displayed. Yet, since the selected text message is a text message that provides information simply (e.g., since a number represented as ‘1577-6700’ 730 is not a normal mobile phone number, despite that a reply is actually impossible), there is a problem that any text inputted to the input window cannot be delivered to a counterpart.

To solve such a problem, the mobile device provides a reply impossible text message with an input window in a format different from that of the related art. In the present specification, a second input window provides a function of answering to user's question and collecting related information only by an operation of IA as well as a simple reply function, whereas a first input window corresponds to an existing input window for a reply.

In some implementations, if an IA conform is a simple information related text message for which a reply is impossible, an input window of a new type, through which a user can ask the IA, is limitedly provided instead of an input window for a reply. For instance, the IA analyzes a specific number, a content of a text message, a use pattern or a use history and is then automatically switched not to a first input window for a reply but to a second input window capable of chatting with the IA. Regarding this, overall technical idea shall be described in detail with reference to FIG. 28 as follows.

FIGS. 28A to 28C illustrate an example mobile device providing an input window varying in accordance with a type of a text message.

Referring to FIG. 28A, if a user selects a reply impossible text message 810, a second input window 820 capable of making a query to an IA is displayed instead of an existing first input window for a reply. A technical reference for determining whether a prescribed text message is a reply impossible text message shall be described in detail with reference to FIG. 29 later.

Referring to FIG. 28B, a command for checking additional information of the selected message is inputted to the second input window. In doing so, referring to FIG. 28C, the IA displays the inputted command 840 and is designed to automatically collect additional information related to the inputted command 840 by accessing at least one of a memory and a server.

If the selected text message 810 is a payment related message, a corresponding map 850 is displayed in order to easily check where a payment is made using a place information included in the message. And, a schedule information 860 mapped to the payment information is displayed.

FIG. 29 illustrates an example database proposing a determination reference for identifying a type of a text message.

Referring to FIG. 29, a text message of a first type and a text message of a second type are saved in a memory in form of a database. According to the definitions in the present specification, the text message of the first type may mean a text message possible for a reply for example. Yet, the text message of the second type may mean a text message impossible for a reply for example. If a text message of a first type and a text message of a second type are defined with reference to another reference as needed, it pertains to another scope of the appended claims and their equivalents.

In some implementations, a first scheme for identifying text messages of two types refers to a phone number of a sender. For instance, if a sender of a text message corresponds to a mobile phone number, it is mapped to a first type. If a sender of a text message corresponds to a case that it is not correspond to a mobile phone number (e.g., a case of ‘1577-0000’, a case of ‘02-1234-5678’, etc.), it is mapped to a second type.

A second scheme for identifying text messages of two types refers to a history. For instance, if there is a history of replying to a text message of the same sender, it is mapped to a first type. If there is no history of replying to a text message of the same sender, it is mapped to a second type.

A third scheme for identifying text messages of two types refers to a keyword. For instance, if ‘bank name’ or ‘credit card name’ is not included in a corresponding text message, it is mapped to a first type. If ‘bank name’ or ‘credit card name’ is included in a corresponding text message, it is mapped to a second type.

Besides, although text messages are identified into two types in FIG. 29, text messages can be identified into at least three types as needed. Moreover, it is possible to propose a new identification reference by combining at least two of the above-mentioned three kinds of references together.

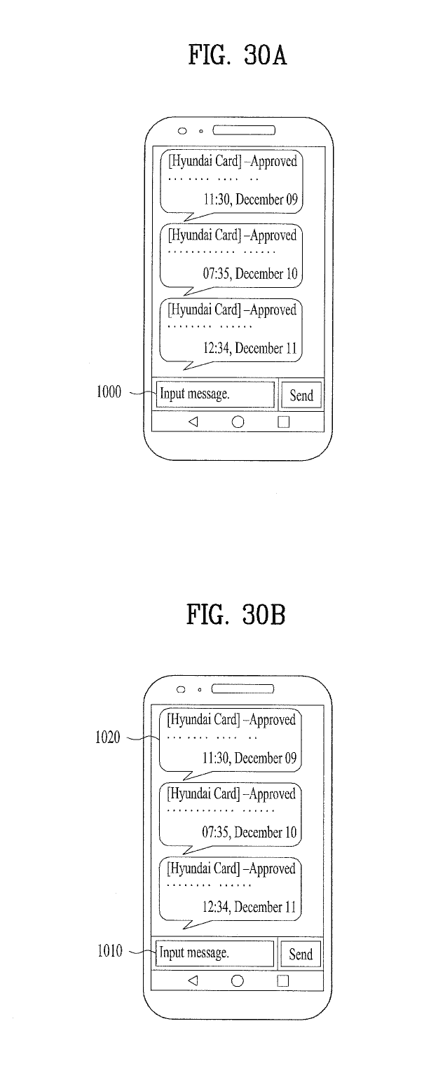

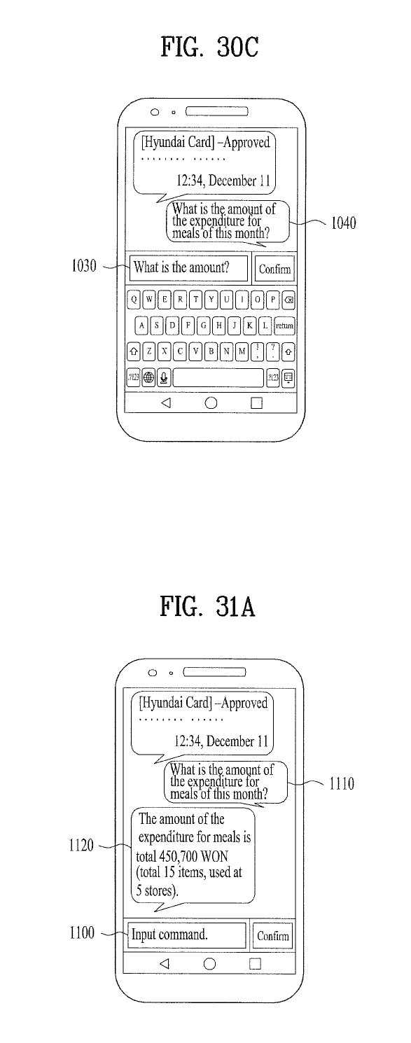

FIGS. 30A to 30C illustrate an example input window for processing a payment related message among text messages of a specific type.

Referring to FIG. 30, if a currently displayed text message is a reply-impossible simple information related text message (e.g., a credit card payment related notification text) [FIG. 30A], a second input window 1010 is displayed instead of a first input window 1000 for a reply [FIG. 30B].

As mentioned in the foregoing description, the second input window 1010 is used not to reply to a corresponding text message sent by a counterpart but to chat with an IA or send a specific command to the IA.

Moreover, referring to FIG. 30B, it is able to confirm that the corresponding text message is used for a simple information through a specific keyword 1020 (e.g., a credit card name) included in the text message.

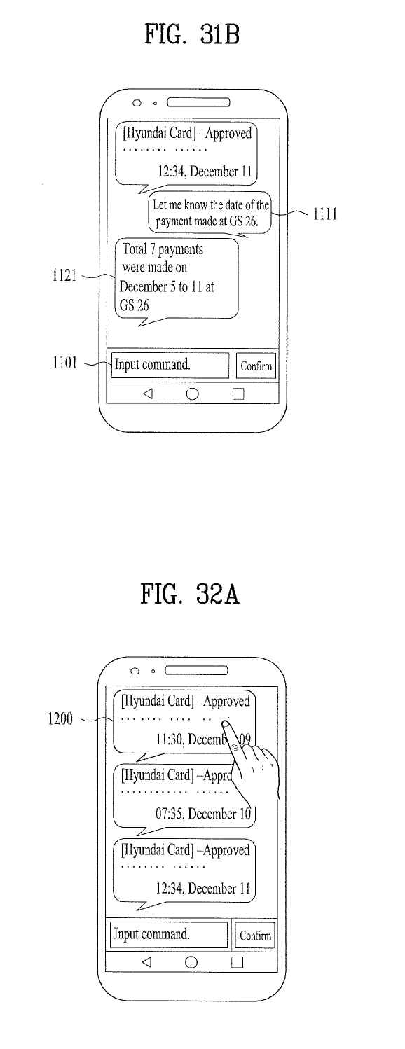

Referring to FIG. 30C, if a specific command 1030 is inputted through the second input window, a corresponding message 1040 is displayed. Yet, the message 1040 is not sent to the sender of the corresponding text message (impossible to be sent) but is used to make a query to an IA loaded on a mobile device only. Meanwhile, a process for the IS to derive a result value for the message 1040 is described in detail with reference to FIG. 31 as follows.

FIG. 31A and FIG. 31B illustrate example process for processing a command inputted to a specific input window for processing a payment information related message among text messages of a specific type.

Referring to FIG. 31A, if a specific command or query 1110 is inputted through a second input window 1100, an IA is designed to display a result value 1120 calculated after collecting a restricted message from text messages saved in a memory of a mobile device.

For instance, a primary filtering is performed on text messages sent by a same sender (e.g., Hyundai Card) only and a secondary filtering is performed on text messages including keywords presumed as restaurants only.

If an option capable of selecting each detailed information is provided by further subdividing the result value 1120, it pertains to another scope of the appended claims and their equivalents. For instance, if ‘15 items’ is selected from the result value derived from the result value 1120 by the IA in FIG. 3A, 15 text messages corresponding to ‘15 items’ are filtered and displayed.

If ‘5 stores’ are selected from the result value 1120 driven by the IA in FIG. 31, corresponding shop information (e.g., map information) is additionally displayed.

On the other hand, referring to FIG. 31B, if a specific command or query 1111 is inputted through a second input window 1101, an IA is designed to display a result value 1121 calculated after collecting a restricted message from text messages saved in a memory of a mobile device. Unlike FIG. 31A, since a specific place ‘GS 25’ is selected, text messages including the keyword ‘GS 25’ are secondarily filtered only among the filtered text messages.

Moreover, if a corresponding date is selected from the result value 1121 derived by the IA in FIG. 31B, it is designed to automatically jump to a text message including information on a payment made on the corresponding date.

If ‘6 times’ is selected from the result value 1121 derived by the IA in FIG. 31B, all corresponding text messages are collected and displayed.

FIGS. 32A to 32C illustrate an example process for processing a command inputted to a specific input window for processing a payment information related message among text messages of a specific type.

Referring to FIG. 32, if a specific message 1200 of a second type (e.g., payment information related) is selected [FIG. 32A], when a command 1210 for making a query to an IA is inputted to a second input window [FIG. 32B], the IA loaded on a mobile device accesses at least one of a memory and Internet.

In FIG. 32B, it is assumed that a query (e.g., ‘What is this?’, ‘What's this?’, etc.) for an additional information on a corresponding text messages is inputted. If so, referring to FIG. 32C, a result value responding to the query 1220 is displayed.

In some implementations, a map information 1230 on a place at which a payment is made is primarily displayed. In some implementations, the information on the payment place can be extracted through a keyword included in the corresponding text message.

Subsequently, a schedule related information 1240 on making a payment is secondarily displayed. In some implementations, the schedule related information 1240 assumes a case that a payment is made through a schedule related application.

FIG. 33A and FIG. 33B illustrate an example process for processing a command inputted to a specific input window for processing a payment information related message among text messages of a specific type.

First of all, in the drawings referred to for the former descriptions, a user should input a specific text to a second input window to have a chat with an IA. Yet, in some implementations described with reference to FIG. 33, a method of automatically creating a list of queries (or questions) highly possible for a user to be curious about is described in detail as follows.

Referring to FIG. 33A, a second input window 1310 corresponding to a payment information related text message 1300, to which it is impossible or unnecessary to reply, is displayed. This can refer to the descriptions of the above examples.

In some implementations, referring to FIG. 33B, at least one or more options 1320 and 1330 for recommending an appropriate content among commands used previously and frequently by a user are displayed instead of the second input window 1310. Hence, there is a technical effect that a time consumed for a user to directly input a desired command can be considerably reduced.

FIG. 34A and FIG. 34B illustrate an example process for processing a command inputted to a specific input window for processing a payment information related message among text messages of a specific type.

Referring to FIG. 34A, a second input window 1410 corresponding to a payment information related text message 1400, to which it is impossible or unnecessary to reply, is displayed.

Subsequently, referring to FIG. 34B, if a specific command 1420 is inputted through the second input window, an IA is designed to automatically collect related information in response to the corresponding command 1420.

In some implementations, an example mobile device is designed to collect all payment information belonging to similar categories without putting limitation on text messages of a same sender. In some implementations, if a text message selected by a user is related to a taxi payment information, payment information of corresponding to transportation means (e.g., taxis, buses (Seoul), buses (Gyunggi), etc.) or payment information of payment means of all transportation means are displayed.

FIG. 35A and FIG. 35B illustrate an example process for processing a command inputted to a specific input window for processing an advertisement information related message among text messages of a specific type.

First of all, implementations simply limited to advertisement related text messages are described in detail with reference to FIGS. 35 to 37 in the following, whereas the former drawings mainly show examples of payment information related text messages. Of course, if other implementations are implemented by combining the examples together, it pertains to the scope of the appended claims and their equivalents.

Referring to FIG. 35A, an advertisement related text message mainly includes a specific information 1500 on a discount period, an event period or the like. If a user selects the specific region 1500 and then inputs a command related to a selected text string to a second input window 1510, referring to FIG. 35B, an IA is designed to display a corresponding command 1520 and to display options 1521 to 1523 capable of setting reminder cycles.

Referring to FIG. 35B, if a mobile device is recognized around a place for selling a product provided by the corresponding text message, the specific option 1523 for displaying a reminder message is selected.

Hence, in case that a user carrying a mobile device moves closer to a specific place (e.g., Shilla Duty Free Shop) (e.g., in a range of 100 meters with reference to GPS information), the corresponding text message is displayed intact, instantly, or by being processed.

In some implementations, the period information recognized from the specific region 1500 is utilized in addition. Hence, if the user moves to a specific place after expiration of the recognized period, a text message is not displayed. Hence, it is advantageous in that unnecessary GPS related data processing can be prevented.

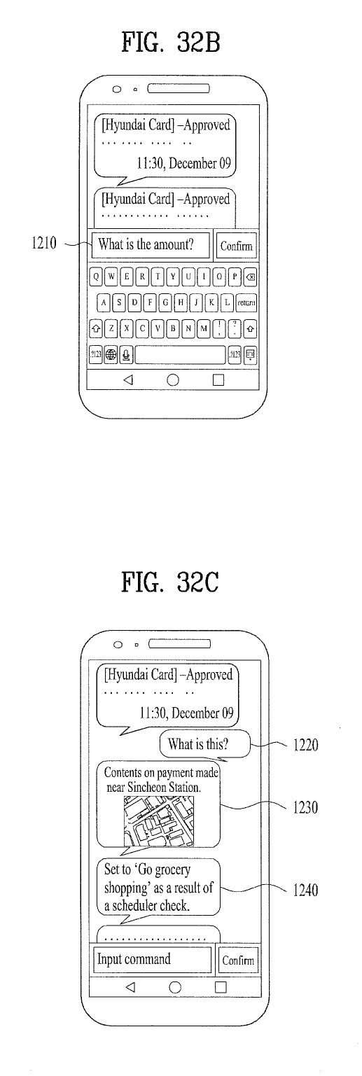

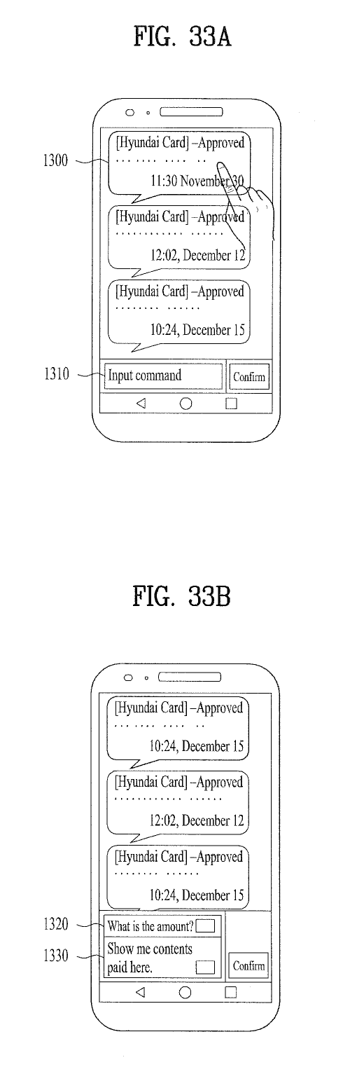

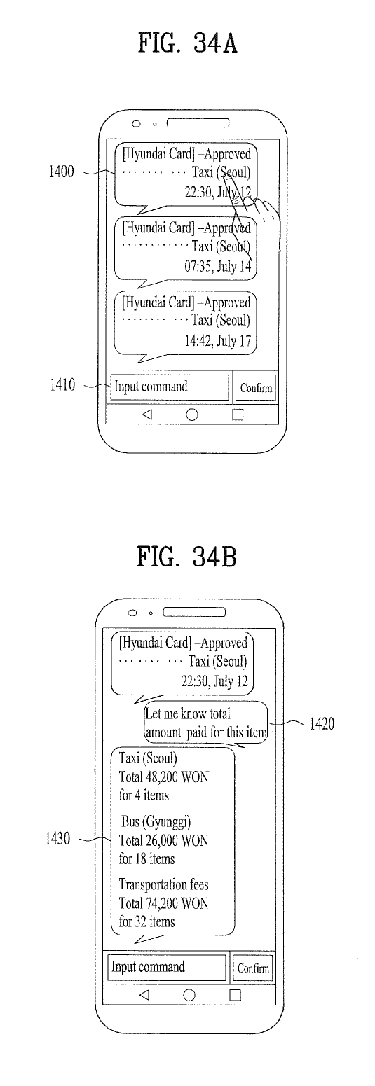

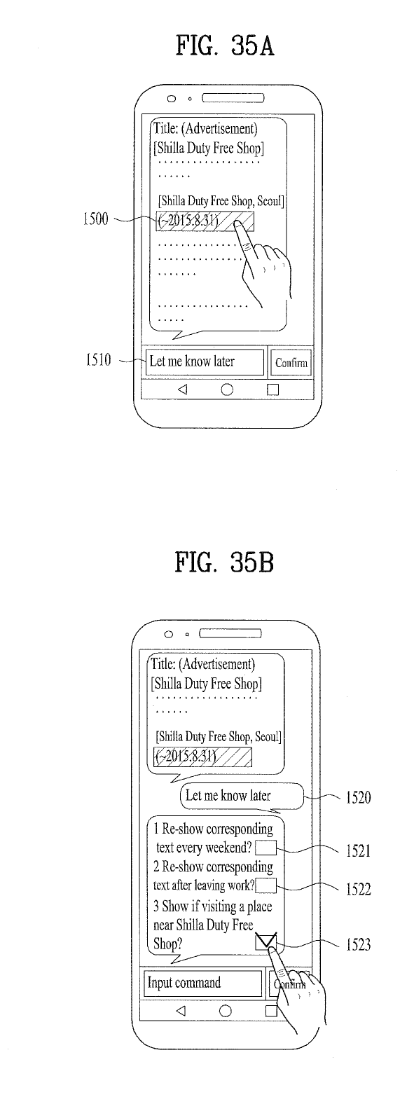

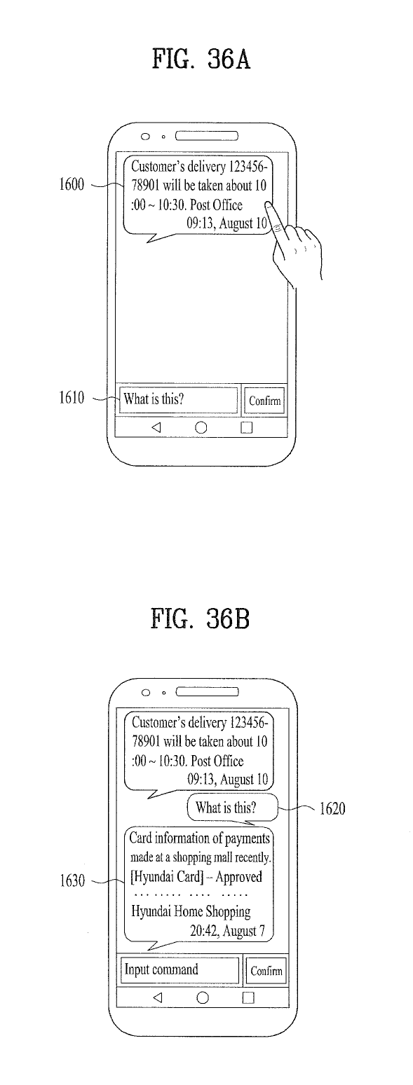

FIG. 36A and FIG. 36B illustrates an example process for processing a command inputted to a specific input window for processing an advertisement information related message among text messages of a specific type.

Referring to FIG. 36A, a second input window 1610 corresponding to an information related text message 1600, to which it is impossible or unnecessary to reply, is displayed. The text message 1600 may include a message related to a delivery service for example.

If a command for making a query to an IA is inputted to the second input window 1610, referring to FIG. 36B, a corresponding message 1620 is displayed. The IA collects additional information by accessing a memory of a mobile device or Internet and then displays a corresponding result value 1630 as well.

In some implementations, the result value 1630 includes at least one of a source (e.g., shopping mall) and a payment date to indicate how the payment was made, for the delivery service related message 1600. Hence, a user can easily confirm why a delivery service is scheduled for the user. Particularly, such a technical effect is expected to be advantageous for a mobile device user frequently giving delivery service orders.

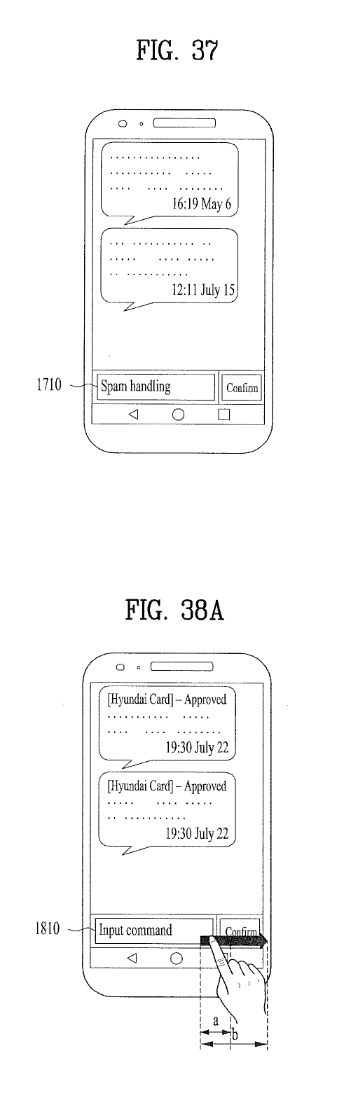

FIG. 37 is diagram to describe further example of a process for processing a command inputted to a specific input window for processing an advertisement information related message among text messages of a specific type.

First of all, according to a related art, a plurality of steps are mandatorily required for spam text registration. Yet, for an information related text message to which it is impossible or unnecessary to reply, referring to FIG. 37, a second input window is displayed only and a command ‘spam handling’ 1710 is then inputted to the displayed second input window. Hence, it is advantageous in not receiving texts from the same sender in the future. Moreover, if there is no IA use history or replay history at all, an option capable of selecting the ‘spam handling’ can be designed to be automatically created and outputted.

FIG. 38A and FIG. 38B are diagrams of graphic images required for switching a first input window and a second input window for text messages to each other.

First of all, in the former drawings, a first input window (for reply) and a second input window (for chat with IA or command) are mainly used in a manner of being determined according to a type of a text message. Yet, in some cases, a user may desire the first input window to be displayed instead of the second input window for a text message to which the user barely replies. The example shown in FIG. 38 solves this problem.

Referring to FIG. 38A, according to a result analyzed by an IA, since a currently displayed text message an information related text message unnecessary to reply to, a second input window is displayed.

Yet, if a user shifts the second input window shown in FIG. 38A in a specific direction (e.g., a right direction) by a swipe for example [1810], referring to FIG. 18B, the second input window is switched to a first input window 1820 capable of making a reply.

Yet, in order to reduce mistakes or errors, only if a distance b continuously touched by a user meets a condition of a preset setting value a, an input window is designed to be switched. Such a design pertains to the scope of the appended claims and their equivalents.

FIGS. 39A to 39C illustrate example graphic images required for configuring a specific type text message related chat window.

First of all, a controller or IA (loadable on the controller or CPU) displays a text message of a second type (impossible or unnecessary to reply to) as a first graphic image, displays a specific command inputted to a second input window as a second graphic image, and displays a result value generated in response to the specific command as a third graphic image. The first to third graphic images include colors different from each other and are designed to be displayed in sequence. Hence, there is a technical effect that a user can identify a command inputted by the user and a result value calculated by the IA easily and conveniently.

Referring to FIG. 39A, all text messages of a second type are displayed in gray and a specific text message 1900 selected by a user is outlined in blue. On the other hand, a text 1910 inputted by the user through the second input window is displayed in yellow and result values 1920 and 1930 calculated for user's query are displayed in orange color. Each of the result values 1920 and 1930 includes a tag like a normal chat message and has a length fixed to ‘a’. Any types of graphic images for identifying text messages pertain to the scope of the appended claims and their equivalents.

Referring to FIG. 39B, all text messages of a second type are displayed in gray and a specific text message 1901 selected by a user is outlined in blue. On the other hand, a text 1911 inputted by the user through the second input window is displayed in yellow and result values 1921 and 1931 calculated for user's query are displayed in orange color. Unlike FIG. 39A, FIG. 39B shows that each of the result values 1921 and 1931 does not include a tag like a normal chat message but has a relatively long length set to ‘A’. Hence, it is advantageous in that a user can check a desired answer more easily and conveniently.

Referring to FIG. 39C, all text messages of a second type are displayed in gray and a specific text message 1902 selected by a user is outlined in blue. On the other hand, a text 1912 inputted by the user through the second input window is displayed in yellow and result values 1922 and 1932 calculated for user's query are displayed in orange color. Although FIG. 39A and FIG. 39B show that a wallpaper 1940/1941 uses the same color of a wall paper a general text message (e.g., a text message of a first type for a chat with a sender), FIG. 39C shows that a wallpaper 1942 uses a color different from that of a chat window for the message of the first type. Hence, it is advantageous in distinguishing user's chat with a normal person from user's communication with IA easily and conveniently.

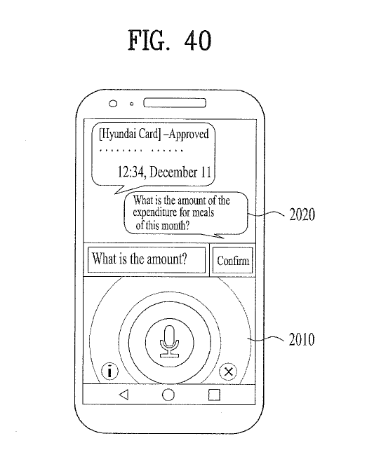

FIG. 40 illustrates an example process for a text message of a specific type to enter a voice recognition step automatically instead of an input window.

Referring to FIG. 40, a command 2020 for a text message of a second type can be inputted through a voice recognition tool 2010 as well as through an input window. For instance, if a second text message is selected, a voice recognition is designed to be automatically triggered, thereby bringing a technical effect in raising a processing speed.

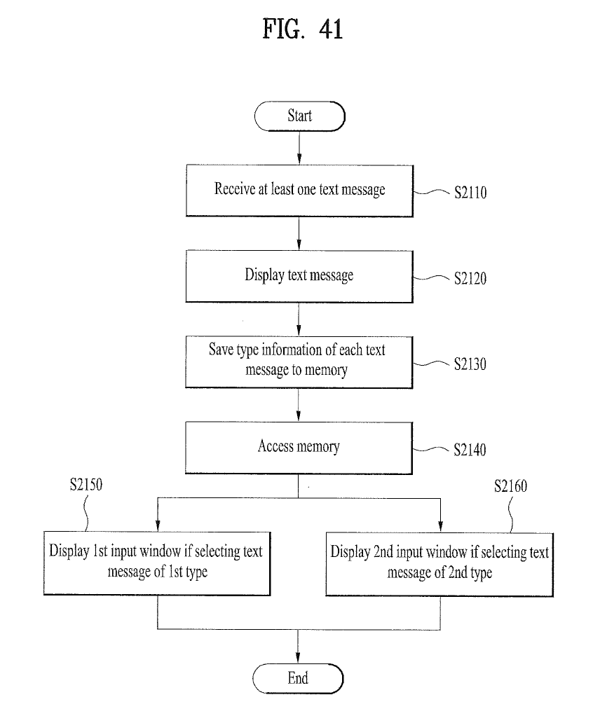

FIG. 41 illustrates an example method of controlling a mobile device providing an input window varying in accordance with a type of a text message. The method shown in FIG. 41 can be understood with reference to the former drawings.

Referring to FIG. 41, a mobile device receives at least one text message [S2110] and then displays the received at least one text message [S2120].

A type information of each of the received at least one text message is saved to a memory [S2130]. And, the memory is accessed [S2140].

By referring to the memory, in response to a command for selecting a text message of a first type, a first input window capable of replying to the selected text message is displayed [S2150]. In response to a command for selecting a text message of a second type, a second input window capable of processing an additional information related to the selected text message is displayed [S2160].

Moreover, data readable by a computer (or mobile device) for implementing the subject matter described above are loaded on each device in advance or downloaded through Internet as need by a user, which obviously pertains to another scope of the appended claims and their equivalents.

What is claimed is:

1. A mobile device, comprising:
a communication module that is configured to receive at least one text message;
a display module that is configured to display the at least one text message;
a user interface module that is configured to detect a command that selects a specific text message from the at least one text message; and
a controller that is configured to:
control the communication module, the display module, and the user interface module;
identify, in response to the command, a different text message that is associated with a specific group that corresponds to the specific text message; and
display, on the display module, the different text message that is associated with the specific group and the specific text message.

2. The mobile device of claim 1, wherein:
the specific group is based on a display region where the user interface module detects the command for selecting the specific text message, and
the mobile device further comprises a memory that is configured to store data that defines a mapping relationship between the specific group and the display region.

3. The mobile device of claim 2, wherein the controller is configured to, based on a first display region of the specific text message being dragged to the different text message, associate both a text message that is received from a sender of the specific text message and a text message that is received from a sender of the different text message with the specific group.

4. The mobile device of claim 3, wherein the controller is configured to, based on a second display region of the specific text message being selected over a preset time or under a preset pressure, associate a text message that is received on a date of receipt of the specific text message with the specific group.

5. The mobile device of claim 4, wherein:
the first display region and the second display region do not overlap,
the first display region corresponds to a display region that extends from a rightmost point of the specific text message to a reference center point on a horizontal axis, and
the second display region corresponds to a display region that extends from a leftmost point of the specific text message to the reference center point.

6. The mobile device of claim 1, wherein the controller is configured to, based on a credit card payment related text message being selected from text messages that are associated with the specific group, display a different credit card payment related text message that is associated with a payment made within a preset time interval or at a preset location using payment information included in the credit card payment related text message.

7. A method of controlling a mobile device, the method comprising:
receiving at least one text message;
displaying the at least one text message;
detecting a command that selects a specific message from the at least one text message;
in response to the command, identifying a different text message that is associated with a specific group that corresponds to the specific text message; and
displaying the different text message that is associated with the specific group and the specific message.

8. The method of claim 7, wherein the specific group is based on a region where the mobile device detects the command for selecting the specific text message.

9. The method of claim 8, comprising:
associating both a text message that is received from a sender of the specific text message and a text message that is received from a sender of the different text message with the specific group based on a first display region of the specific text message being dragged to the different text message.

10. The method of claim 9, comprising:
associating a text message received on a date of receipt of the specific text message with the specific group based on a second display region of the specific text message being selected over a preset time or under a preset pressure.

11. The method of claim 10, wherein:
the first display region and the second display region do not overlap,
the first display region corresponds to a display region that extends from a rightmost point of the specific text message to a reference center point on a horizontal axis, and
the second display region corresponds to a display region that extends from a leftmost end point of the specific text message to the reference center point.

12. The method of claim 7, comprising:
displaying a different credit card payment related text message that is associated with a payment made within a preset time interval or at a preset location using payment information included in the credit card payment related text message based on a credit card payment related text message being selected from text message that are associated with the specific group.

13. A mobile device, comprising:
a communication module that is configured to receive at least one text message;
a display module that is configured to display the at least one text message;
a memory that is configured to store type information of each of the at least one text message; and
a controller that is configured to:
control the communication module, the display module, and the memory;
in response to a command that selects a text message of a first type, display, on the display module, a first input window that is configured for replying to the selected text message; and
in response to a command that selects a text message of a second type, display, on the display module, a second input window that is configured for processing additional information that is related to the selected text message.

14. The mobile device of claim 13, wherein the first input window and the second input window are displayed in different positions or in a same position.

15. The mobile device of claim 13, wherein:
the memory is configured to store at least two message information types,
the text message of the first type is associated with a sending phone number that corresponds to a mobile phone number, and
the text message of the second type is associated with a sending phone number that does not correspond to a mobile phone number.

16. The mobile device of claim 13, wherein:
the memory is configured to store at least two message information types, and
the controller is configured to identify text messages of the first type and text messages of the second type based on a reply history.

17. The mobile device of claim 13, wherein the controller is configured to, in response to the second input window receiving a specific command, display payment place information that is included in the text message of the second type as a map.

18. The mobile device of claim 13, wherein the controller is configured to:
identify at least one command that was previously inputted into the second input window; and
display, on the display module, a selectable representation of the at least one command.

19. The mobile device of claim 13, wherein the controller is configured to, in response to a command that selects the text message of the second type, identify information of a different text message of the second type and of the selected text message.

20. The mobile device of claim 19, wherein the controller is configured to identify the different text message based on a name of a credit card or a bank being included in the selected text message, the different text message of the second type including the credit card or the bank name or includes a random credit card or bank name.

21. A method of controlling a mobile device, the method comprising:
receiving at least one text message;
displaying the at least one text message;
storing, in memory, type information of each of the at least one text message;
in response to a command that selects a text message of a first type, displaying a first input window that is configured for replying to the selected text message; and
in response to a command that selects a text message of a second type, displaying a second input window that is configured for processing additional information that is related to the selected text message.
